(19) United States
(12) Patent Application Publication
(10) Pub. No.: US 2026/0126363 A1
(43) Pub. Date: May 7, 2026

(54) METHODS AND APPARATUS FOR CHARACTERIZATION OF POROUS MATERIALS

(71) Applicant: UNIVERSITY OF WYOMING, Laramie, WY (US)

(72) Inventors: Omer A. SALIM, Laramie, WY (US); Sagar Hussain SABUZ, Laramie, WY (US); Mohammad PIRI, Laramie, WY (US)

(21) Appl. No.: 19/376,722

(22) Filed: Oct. 31, 2025

Related U.S. Application Data
(60) Provisional application No. 63/715,334, filed on Nov. 1, 2024.

(51) Int. Cl. G01N 5/02

(52) U.S. Cl. CPC G01N 5/02

(57) ABSTRACT

Embodiments described herein generally relate to new methods and apparatus for characterizing porous materials, such as nanoporous materials. In an embodiment, a gravimetric method for characterizing a nanoporous material is provided. The gravimetric method includes contacting a nanoporous material with an adsorbate gas, the nanoporous material positioned inside a core holder. The gravimetric method further includes collecting adsorption data, desorption data, or combinations thereof, the adsorption data and desorption data comprising gravimetric data. The gravimetric method further includes plotting an adsorption isotherm from the adsorption data, a desorption isotherm from the desorption data, or combinations thereof. The gravimetric method further includes converting the gravimetric data from gravimetric values to volumetric values. The gravimetric method further includes selecting a pore geometry for the nanoporous material. The gravimetric method further includes determining one or more characteristics of the nanoporous material.

### CROSS-REFERENCE TO RELATED APPLICATIONS

This application claims benefit of and priority to U.S. Provisional Patent Application No. 63/715,334, filed on Nov. 1, 2024, which is incorporated herein by reference in its entirety.

### FIELD

Embodiments of the present disclosure generally relate to new methods and apparatus for characterizing porous materials, such as nanoporous materials.

### BACKGROUND

Nanoporous materials offer a wide range of applications across industries due to their distinctive characteristics. For example, nanoporous materials are used in various applications, including gas storage and separation, enabling hydrogen storage and carbon dioxide capture. In catalysis, nanoporous materials function as catalyst supports in automotive emissions control and chemical synthesis. Nanoporous materials play a role in water purification systems, drug delivery for controlled release, and energy storage devices such as supercapacitors and batteries. Additionally, nanoporous materials find application in sensing technologies for environmental monitoring and medical diagnostics, as well as in membrane technology for filtration and separation processes. The thermal insulation characteristics of nanoporous materials render them advantageous for electronic device thermal management. Overall, nanoporous materials contribute significantly to advancements in technology and sustainable solutions across various sectors. Therefore, accurate characterization of nanoporous materials is beneficial for identifying performance parameters and expanding applications across technology sectors. Precise characterization enables researchers and engineers to understand the structural properties, such as pore size distribution, surface area, and pore volume, which directly influence their functionality in such applications.

Conventional technologies for studying pore characteristics of nanoporous materials typically involve nitrogen adsorption or desorption experiments at low pressures (up to 1 atm). However, the size of nitrogen molecules prohibit their entry into certain pores and the inability to perform high pressure experiments prevents detailed determination of pore characteristics under various environmental conditions. Further, conventional technologies rely on imprecise volumetric measurements and make use of equations of state to estimate the adsorbed volumes, which is an indirect estimation of volumetric parameters, leading to low reproducibility and accuracy.

There is a need for new methods and apparatus for characterizing porous materials.

### SUMMARY

Embodiments of the present disclosure generally relate to new methods and apparatus for characterizing porous materials, such as nanoporous materials. Unlike conventional technologies, embodiments described herein utilize a novel gravimetric method for accurately characterizing nanoporous materials by estimating various characteristics (quantitative and qualitative parameters) of the nanoporous materials. Quantitative parameters that may be estimated or determined include specific surface area, pore size, pore size distribution, specific pore volume, or combinations thereof using any suitable theoretical method such as Brunauer-Emmett-Teller (BET), Barrett-Joyner-Halenda (BJH), density functional theory (DFT), or non-local DFT (NLDFT), among others. Qualitative parameters that may be estimated or determined include pore networks, texture, and combinations thereof, among others.

In contrast to conventional technologies, embodiments described herein eliminate errors inherent with traditional methods through the use of, for example, high-precision balances (mass comparators), ensuring reliable estimation of, for example, specific surface area, pore size distribution, and/or specific pore volume, among other characteristics due to the use of direct measurement of the adsorbed mass (gravimetric technique). Embodiments of the present disclosure may also be compatible with a wider range of temperatures and pressures relative to conventional technologies, enabling characterization of nanoporous materials under various environmental conditions to capture their diverse properties. Unlike conventional technologies, embodiments of the present disclosure enable the characterization of nanoporous materials using different types of adsorbates such as hydrogen (H₂), helium (He), carbon dioxide (CO₂), nitrogen (N₂), hydrocarbons (for example, methane, ethane, etc.), and natural gas, enabling comprehensive analysis of material properties across various applications and research domains. Moreover, gravimetric methods described herein overcome the inherent limitation of the other conventional gravimetric methods which utilize buoyancy corrections due to placement of the sample, mass balance, and gas collectively in the same settings. In contrast, and in the various embodiments described herein, the placement of the sample and gas remains isolated inside a core holder and the core holder is kept hanging to the mass balance which enables direct measurement, thus overcoming the buoyancy correction. Overall, embodiments of the present disclosure provide tailored nanoporous material characterization, enabling robust and efficient tools for nanoscience and nanotechnology research and development.

In an embodiment, a gravimetric method for characterizing a nanoporous material is provided. The gravimetric method includes contacting a nanoporous material with an adsorbate gas, the nanoporous material positioned inside a core holder. The gravimetric method further includes collecting adsorption data, desorption data, or combinations thereof, the adsorption data and desorption data comprising gravimetric data. The gravimetric method further includes plotting an adsorption isotherm from the adsorption data, a desorption isotherm from the desorption data, or combinations thereof. The gravimetric method further includes converting the gravimetric data from gravimetric values to volumetric values. The gravimetric method further includes selecting a pore geometry for the nanoporous material. The gravimetric method further includes determining one or more characteristics of the nanoporous material.

In another embodiment, a gravimetric method for characterizing a nanoporous material is provided. The gravimetric method includes disposing a nanoporous material inside a core holder of a characterization apparatus. The gravimetric method further includes applying a vacuum to one or more components of the characterization apparatus. The gravimetric method further includes setting a temperature at which the adsorption data, desorption data, or combinations thereof are collected. The gravimetric method further includes contacting the nanoporous material with an adsorbate gas. The gravimetric method further includes collecting adsorption data, desorption data, or combinations thereof, the adsorption data and desorption data comprising gravimetric data. The gravimetric method further includes plotting an adsorption isotherm from the adsorption data, a desorption isotherm from the desorption data, or combinations thereof. The gravimetric method further includes converting the gravimetric data from gravimetric values to volumetric values. The gravimetric method further includes selecting a pore geometry for the nanoporous material. The gravimetric method further includes determining one or more characteristics of the nanoporous material.

In another embodiment, a gravimetric nanocondensation apparatus for characterizing a nanoporous material is provided. The gravimetric nanocondensation apparatus includes a core holder, and a pressure sensor coupled to the core holder, the pressure sensor configured to sense a pressure within the core holder and produce a pressure signal. The gravimetric nanocondensation apparatus further includes and a mass comparator operationally connected to an exterior of the core holder and a valve configured to control flow of adsorbate gas into the core holder and configured to control pressure within the core holder. The gravimetric nanocondensation apparatus further includes a controller coupled to the pressure sensor, the valve, and the mass comparator. The controller is configured to cause flow of the adsorbate gas into the core holder to contact the nanoporous material by opening the valve and cause collection of adsorption data, desorption data, or combinations thereof. The adsorption data and desorption data comprises gravimetric data by logging data from the pressure sensor and the mass comparator.

In another embodiment, a gravimetric nanocondensation apparatus for characterizing a nanoporous material is provided. The gravimetric nanocondensation apparatus includes a chamber having a port therein and a mass comparator positioned above and outside of the chamber. The gravimetric nanocondensation apparatus further includes a hook or wire hanging inside the chamber and attached to a bottom surface of the mass comparator, the hook or wire traversing through an interior and an exterior of the chamber via the port The gravimetric nanocondensation apparatus further includes a core holder positioned inside the chamber and hanging from the hook or the wire, the mass comparator operationally connected to an exterior of the core holder. The gravimetric nanocondensation apparatus further includes a pressure sensor coupled to the core holder, the pressure sensor configured to sense a pressure within the core holder and produce a pressure signal. The gravimetric nanocondensation apparatus further includes a valve configured to control flow of adsorbate gas into the core holder and configured to control pressure within the core holder. The gravimetric nanocondensation apparatus further includes a pump coupled to the valve, the pump configured to pressurize the adsorbate gas. The gravimetric nanocondensation apparatus further includes a controller coupled to the pressure sensor, the valve, and the mass comparator. The controller is configured to cause flow of the adsorbate gas from the pump and into the core holder to contact the nanoporous material by opening the valve and cause collection of adsorption data, desorption data, or combinations thereof. The adsorption data and desorption data comprises gravimetric data by logging data from the pressure sensor and the mass comparator.

### BRIEF DESCRIPTION OF THE DRAWINGS

So that the manner in which the above recited features of the present disclosure may be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a schematic showing differently-sized molecules inside differently-sized pores of a nanoporous material.

FIG. 2 is a schematic diagram of a characterization apparatus according to at least one embodiment.

FIG. 3 is a schematic diagram of a characterization apparatus (a gravimetric nanocondensation apparatus) according to at least one embodiment.

FIG. 4 shows non-limiting operations of a method for characterizing nanoporous materials according to at least one embodiment.

FIG. 5 is experimental data acquired of an example mesoporous material, Mobil Composition Matter No. 41 (MCM-41, 100 Å).

FIG. 6 shows the experimental data of FIG. 5 converted to volumetric values.

FIG. 7 shows a plot of adsorption versus relative pressure of MCM-41 (100 Å) used to determine the specific surface area by the Brunauer-Emmett-Teller (BET) method.

FIG. 8 shows a plot of specific pore volume and specific surface area of MCM-41 (100 Å) by Barrett-Joyner-Halenda (BJH) method.

FIG. 9 shows BJH pore size distribution data of an MCM-41 (100 Å) sample that was determined using embodiments described herein.

FIG. 10 shows pore size distribution data for an MCM-41 (80 Å) sample that was determined using embodiments described herein.

FIG. 11 shows BJH pore size distribution data for an MCM-41 (80 Å) sample that was determined using embodiments described herein.

FIG. 12 shows pore size distribution data for MCM-41 (80 Å), MCM-41 (100 Å), and MCM-41 (120 Å) samples that were determined using a conventional nitrogen sorption method.

FIG. 13 shows specific pore volume (SPV) and specific surface area (SSA) data for the MCM-41 (100 Å) sample that were determined according to embodiments described herein.

FIG. 14 shows SPV and SSA data for the MCM-41 (80 Å) sample that were determined according to embodiments described herein.

FIG. 15 shows SPV and SSA data for the MCM-41 (120 Å) sample that were determined according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to new methods and apparatus for characterizing porous materials. The methods and apparatus for characterizing porous materials may be used to determine properties of a sample and to study phase interactions within the sample, among other applications. The sample may include a porous material, such as a nanoporous material. The porous material may be in a powder form, may be in a solid core, may be comprised of solid aggregate states, or combinations thereof. A powder form of the porous sample may include porous or solid nanoparticles or crushed rocks. A solid core may include a cylindrical rock. The sample may further include a fluid, for example, a gas, a liquid, or combinations thereof.

The sample may be studied by recording the mass and/or composition of a fluid as a function of time (time series data). Phase interactions may include adsorption, desorption, and capillary condensation, and may be analyzed gravimetrically via recordings of mass and/or composition of the fluid as a function of time. For adsorption/desorption and capillary condensation phenomena, the term “gravimetric” is used where the mass of the fluid indicates its phase behavior. Effects of environmental parameters such as temperature and pressure on the aforementioned interactions may also be studied and characterized via use of embodiments described herein.

Methods described herein may be conducted in a static mode, involving the introduction of fluid pulses into the sample to facilitate equilibration (pressure stabilization), and subsequently acquiring the required measurements. As an example of static mode, a gas may be injected into the system (reaching the sample) then allowed to equilibrate. Here, the gas will diffuse inside the sample, the pressure will drop due to gas diffusion, and when the pressure stabilizes (for example, stops dropping) that means the equilibrium is reached and the final measurements may be taken.

Alternatively, methods described herein may be carried out in a dynamic mode, allowing the fluid to flow through the sample. As an example of dynamic mode, the fluid may be continuously injected to the system, allowing the fluid to flow through the sample. In both static and dynamic modes, system data such as temperature, mass, pressure, or combinations thereof may be continuously recorded but the injection modes are different.

Gravimetric apparatus use high-precision balances to measure the mass of a fluid in real time. The use of high-precision balances, as provided by embodiments of the present disclosure, negates the possibility of incurring errors through equation-of-state volume calculations and error accumulation, and enables understanding of the kinetics of adsorption, desorption, and capillary condensation. Errors through equation-of-state volume calculations and error accumulation are inherent to conventional methods such as volumetric methods. Confining the sample inside an isolated core holder, as provided by embodiments of the present disclosure, negates the possibility of incurring errors through buoyancy correction, which are inherent to other conventional gravimetric methods. Buoyancy corrections are calculations to adjust mass measurements for the buoyant force of the surrounding fluid phase. Buoyancy corrections are calculations applied to compensate for the apparent change in measured mass caused by the upward buoyant force exerted by the surrounding fluid phase (that is, the gas or fluid under study (adsorbate phase)) on the sample and balance components. In conventional gravimetric systems, the sample and the balance pan are both immersed in the same adsorbate gas during measurements. Because the density of this gas changes with temperature and pressure, it exerts a variable buoyant force that alters the apparent weight of the sample. To obtain accurate adsorption or storage data by conventional gravimetric methods, this buoyant effect must be estimated and corrected mathematically based on gas properties and chamber geometry.

In conventional gravimetric systems, the sample is placed in an open sample holder within the main chamber, and the adsorbate gas is introduced to fill the entire chamber volume. Under such conditions, both the mass balance pan and the sample are immersed in the same fluid phase (adsorbate gas or adsorbate phase), which alters the apparent weight of the sample due to buoyant forces acting on it. Consequently, a buoyancy correction must be applied to estimate the true amount of gas adsorbed or stored within the porous material, a process that introduces additional uncertainty and potential error.

In contrast, embodiments of the present disclosure isolate the sample and the adsorbed phase (stored phase) within a sealed core holder that is mechanically coupled to the mass balance (or mass comparator) but fluidly independent from the chamber (e.g., an environmental chamber). This configuration enables the mass balance to measure only the true mass change of the sample, without the influence of surrounding gas density variations or fluid displacement effects. The design may also serve to protect the sample from external contaminants (humidity/water vapor/other gases) and may also help ensure that the adsorption behavior reflects the intrinsic interaction between the adsorbate and the porous medium. To illustrate this difference conceptually, if a person were to weigh themselves while submerged in a swimming pool, the apparent weight would be reduced by the buoyant force of the displaced water, requiring correction to determine their true weight. However, if the same measurement were taken on dry ground, no correction would be needed, and the result would be inherently accurate. Similarly, embodiments of the present disclosure perform its measurement in an “isolated air” equivalent (outside the buoyant environment) thereby providing a direct and accurate determination of mass change without correction or external interference observed with conventional technologies.

Furthermore, in contrast to conventional technologies, embodiments of the present disclosure include the use of mass comparators. Mass comparators are compatible with extreme temperatures and pressures and may be used for flow-through measurements, capabilities that are extremely difficult, if not impossible, to achieve with other types of apparatus.

### Definitions

“Porous material” includes a specimen containing minute cavities. The porous material may include natural samples (for example, porous rock), consolidated porous media, and/or unconsolidated porous media (for example, powders). Minute cavities of a porous material may contain liquids and/or gases. The size, structure, and distribution of these cavities determines the porosity of a given material. The porous material may be a nanoporous material. Nanoporous materials may include a framework or matrix with a structure of pores, each being about 100 nm or smaller and may be subdivided into three categories: microporous materials with pores having pore sizes between about 0.2 nm and about 2 nm; mesoporous materials with pores having pore sizes between about 2 nm and about 50 nm, and macroporous materials with pores having pore sizes between about 50 nm and about 1,000 nm. Porous materials may include MCM-41 samples which are mesoporous silica samples.

A “fluid-solid system” refers to a system that includes at least one fluid phase and at least one solid phase. The solid phase may include a porous material. Phase interactions of a fluid-solid system may be dynamic or static. Phase interactions of the fluid-solid system may be characterized by structural mechanics, fluid dynamics, thermodynamics, or combinations thereof. A fluid-solid system may include a porous material and a fluid contained within a core holder. The porous material of the fluid-solid system may be, or include, a porous rock, consolidated media, or unconsolidated media.

An “chamber” includes an enclosure in which environmental parameters including temperature, pressure, and humidity may be controlled. A chamber may be used to test specific conditions on samples or experiments or to store sensitive materials. Chambers may differ greatly in size and equipment. A chamber may be equipped with sample holders (core holders). A chamber may be outfitted with pressure transducers and differential mass balances (or mass comparators) feeding measurement data into a data acquisition box. A chamber may function as a thermostat, capable of temperature control of ±0.1 K. The chamber may also be referred to herein as an environmental chamber.

A “core holder” includes an apparatus for holding a sample such as a porous material, a fluid-solid system, or combinations thereof. The core holder may be used for fluid permeability experiments and pore characterization experiments. Conditions within the core holder may be measured and applied to the sample. A pressure within the core holder may be measured using a pressure sensor. Changes in mass within the core holder may be measured using a mass comparator.

“Fluid communication” includes the arrangement of two or more elements of an apparatus or system such that a fluid may be flowed, for example, to, past, through, or from one object to another. For example, two elements are in selective fluid communication with one another if a fluid flow path including one or more valves is provided between the two elements. Accordingly, the flow path may be selectively opened or closed via, for example, operation of the one or more valves.

“Selective fluid communication” includes the arrangement of two or more elements of an apparatus or system such that a fluid may be flowed, for example, to, past, through, or from one object to another selectively. For example, two elements are in selective fluid communication with one another if a fluid flow path including one or more valves is provided between the two elements. Accordingly, the flow path may be selectively opened or closed via, for example, operation of the one or more valves.

“Capillary condensation” includes processes by which a fluid in vapor phase adsorbs into a porous medium, builds multiple layers of the adsorbed vapor phase, and at a certain temperature and pressure nucleates into a condensed phase that fills the pores of the porous medium. The terms “capillary condensation” and “nanocondensation” are used interchangeably unless the context indicates otherwise.

### Characterization Apparatus

Embodiments of the present disclosure generally relate to apparatus for characterizing nanoporous materials.

Embodiments described herein may be utilized with characterization apparatus described in, for example, U.S. Pat. No. 10,302,540, which is incorporated herein by reference in its entirety to the extent not inconsistent with the disclosure in this application. Embodiments described herein may be utilized with automated apparatus for characterization of porous materials and/or fluid-solid systems such as those described in U.S. Pat. No. 12,000,855, which is incorporated herein by reference in its entirety to the extent not inconsistent with the disclosure in this application.

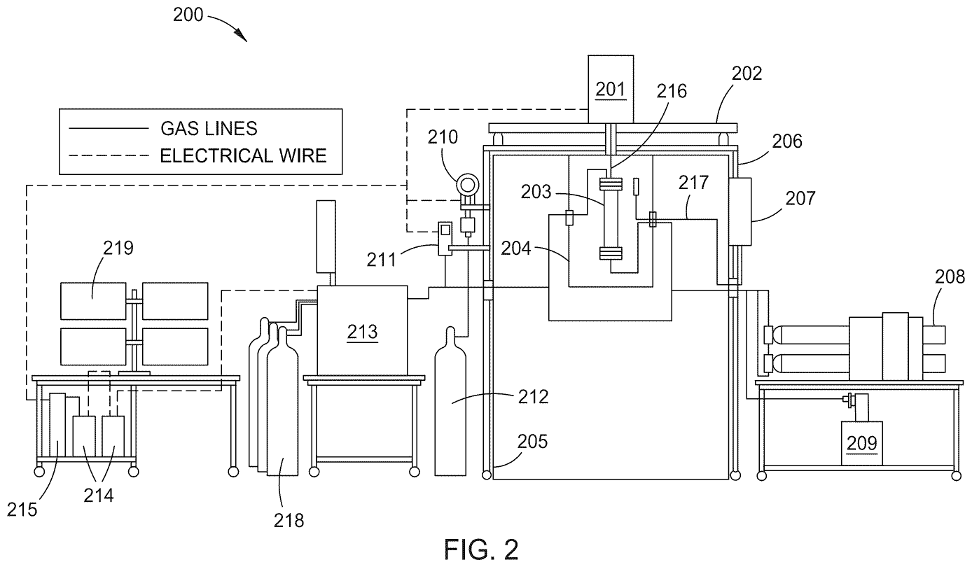

FIG. 2 is a schematic diagram of an embodiment of an apparatus 200 for characterizing a porous material and/or a fluid-solid system according to at least one embodiment. The apparatus 200 shown in FIG. 2 may be operated manually, as each point of pressure change may be decided and manually executed by human interaction. This manual nature of the apparatus causes it to be idle for extended periods of times and hence its full potential is not fully utilized. In addition, the amount of data (and final output resolution) generated with manual operation is much lower than what could be accomplished with an automated system. Selected parts of the apparatus 200 illustrated in FIG. 2 are shown in Table 1.

TABLE 1

| Ref. No. | Part |
|---|---|
| 201 | Balance or mass comparator |
| 202 | Anti-vibration table |
| 203 | Core holder |
| 204 | Draft shield |
| 205 | Chamber |
| 206 | Frame |
| 207 | Thermocouple power supply |
| | and data logger |
| 208 | Dual cylinder pump |
| 209 | Turbomolecular pump |
| 210 | Pressure transducer |
| 211 | Vacuum gauge |
| 212 | Gas cylinders |
| 213 | Gas chromatograph |
| 214 | Computers |
| 215 | Data acquisition box |
| 216 | Insulated cable |
| 217 | Thermocouple wire |
| 218 | Chromatographic gases |
| 219 | Monitors |

The apparatus 200 may include various additional elements that may enable automation among other advantages. For example, and in addition to one or more of the parts 201-219, apparatus described herein may include an electric valve, a remote-control unit, an advanced computer algorithm, or combinations thereof.

The mass comparator 201 is positioned on top of an anti-vibration table 202 and frame 206 while hanging an adsorbent inside the chamber 205 from a hook or insulated cable 216 on the bottom of the mass comparator 201. Such a configuration may serve to protect a mass comparator's sensitive electronics in experiments carried out at extreme conditions (for example, reservoir temperatures and reservoir pressures). Other protective measures may include containing experimental gases within high pressure, high temperature tubing and the core holder, which houses the adsorbent.

The chamber 205 may be used to ensure, for example, precise temperature control of the apparatus 200. The chamber 205 may be customized to include an extended lower operating temperature of −100° C. and an extended upper operating temperature of 232° C. The chamber 205 may be customized to include the capacity to interface with four or more resistance temperature detectors (RTDs) and two or more thermocouples. The chamber 205 may be customized to include ports on both the sides and on top of the chamber 205. Including ports on both the sides and on top of the chamber 205 may be useful to pass lines and wires into and out of the chamber 205, including the wire suspending the core holder 203 from the mass comparator 201. For example, thermocouple and/or RTD wires 217 may be positioned inside the chamber 205, and the thermocouple and/or RTD box (for example, the thermocouple power supply and data logger 207) may be placed outside of the chamber 205. The ports may also be useful to anchor a draft shield 204, which may be fastened around the core holder 203 to prevent air currents in the chamber 205 from impairing the resolution of the mass comparator 201. An illustrative, but non-limiting, example of a chamber 205 may include a Thermotron XSE-600-3-3-MS. Other chambers or suitable apparatus for controlling temperature are contemplated.

The chamber 205 may be purged with a non-reactive gas, for example, gaseous nitrogen. Purging the chamber 205 with a non-reactive gas may increase the safety of high-pressure, high-temperature reservoir condition experiments. Also, purging the chamber 205 with a non-reactive gas may help mitigate or prevent ice formation during low temperature experiments. The non-reactive gas may be stored in one or more gas cylinders 212 positioned outside of the chamber 205 and filtered through a gas dryer (not shown) prior to entering the chamber 205. A frame 206, or support structure, may be placed over the chamber 205 to hold or support the anti-vibration table 202.

A pump 208 is utilized to pressurize fluids under investigation. An illustrative, but non-limiting, example of a pump 208 is a dual cylinder pump such as a dual cylinder Q6000 Quizix pump. Other pumps or suitable apparatus for pressurizing fluids are contemplated. If the pump 208 has a high maximum operating temperature, it may be housed outside of the chamber 205. For example, the dual cylinder Q6000 Quizix pump has a maximum operating temperature of 160° C. and may be housed outside of the chamber 205. Other pumps may have lower or higher maximum operating temperatures and may be housed either outside or inside of the chamber 205. In some embodiments, which may be combined with other embodiments, both cylinders of the pump 208 may be utilized to pressurize fluids. In experiments utilizing the injection of pre-heated fluids, heating tape may be used to heat the cylinders of the pump 208. The use of heating tape may serve as an alternative to housing the cylinders of the pump 208 inside of the chamber 205.

A turbomolecular pump 209 may be used in the apparatus 200 to vacuum out the system and de-gas the adsorbent. The turbomolecular pump 209 may be a hydrocarbon-free turbomolecular pump. A hydrocarbon-free turbomolecular pump has magnetic bearings instead of oil-lubricated bearings. Consequently, lubricant fumes do not adsorb to tubing during vacuuming. Hydrocarbon-free turbomolecular pumps may achieve vacuum levels of at least 10⁻⁶ mbar.

A data acquisition box 215 is positioned outside of the chamber 205. The data acquisition box 215 is utilized to acquire data from various parts of the apparatus 200 such as the mass comparator 201 and the thermocouple power supply and data logger 207. The data acquisition box 215 is coupled to the mass comparator 201 and the thermocouple power supply and data logger 207 by electrical wires (indicated as dashed lines). Mass readings are taken from the mass comparator 201. The data acquisition box 215 is also coupled to a pressure transducer 210 (or pressure sensor) and a vacuum gauge 211, which are positioned outside of the chamber 205, and are used to take pressure readings. Any suitable pressure transducer and vacuum gauge may be used.

A gas chromatograph 213 may be used to monitor the concentrations of fluids adsorbed and desorbed for the advanced study of multi-component fluids. Chromatographic gases 218 are coupled to the gas chromatograph 213. A computer 214 and monitors 219 are utilized, for example, to control the gas chromatograph 213 and to view experimental results. An illustrative, but non-limiting, example of a gas chromatograph 213 that may be used is an Agilent 7890B GC system. Other suitable gas chromatographs are contemplated.

The gas chromatograph 213 may be customized to analyze some or all fluids encountered in capillary condensation experiments. For example, the gas chromatograph 213 may be customized to be capable of Detailed Hydrocarbon Analysis (DHA) to study hydrocarbon fluids. Additionally, or alternatively, the gas chromatograph 213 may be customized to be capable of Simulated Distillation for crude oil. Additionally, or alternatively, the gas chromatograph 213 may be customized to be capable of analyzing fixed gases (for example, nitrogen and carbon dioxide). The plumbing of the gas chromatograph 213 may be made out of suitable materials such as Hastelloy, and may be fitted with a high-pressure (for example, about 3,000 psi) and/or heated gas inlet valve to ensure the proper analysis of reservoir fluids.

The gas chromatograph 213 may also be used to measure the composition of a bulk fluid and/or the composition of a confined fluid. To measure the composition of confined fluid, for example, a liquid nitrogen trap may be used to draw the confined fluid out of an adsorbent in the core holder 203. The confined fluid may be collected from the liquid nitrogen trap and then transferred to the gas chromatograph 213 for analysis.

An apparatus for characterizing a porous material and/or a fluid-solid system that may be used with embodiments described herein is described in, for example, U.S. Pat. No. 10,302,540, which is incorporated herein by reference in its entirety to the extent not inconsistent with the disclosure in this application.

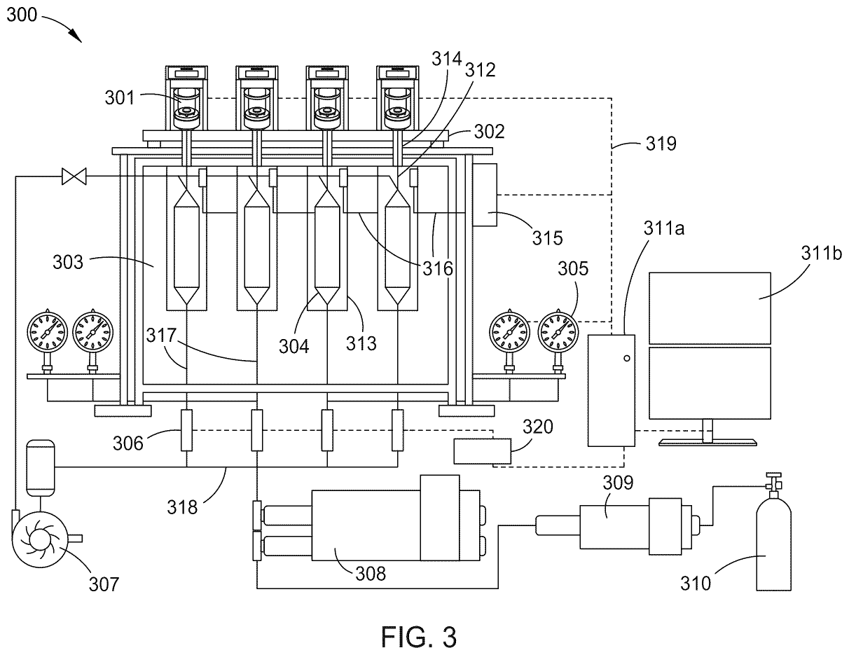

In another embodiment, which may be combined with other embodiments, apparatus for characterizing a porous material and/or a fluid-solid system may include a gravimetric nanocondensation apparatus. An illustrative, but non-limiting, example of a gravimetric nanocondensation apparatus 300 is shown in FIG. 3, further described below. Various components of the gravimetric nanocondensation apparatus 300 shown in FIG. 3 may be similar to those components described above with respect to apparatus 200 shown in FIG. 2.

Selected parts of the gravimetric nanocondensation apparatus 300 are shown in Table 2. The number of elements shown in FIG. 3 and described herein are for illustrative purposes and non-limiting. For example, there may be more or less than four core holders, more or less than four mass comparators, more or less than four pressure sensors, more than one gas cylinder, etc. Additional elements may be utilized with the gravimetric nanocondensation apparatus 300.

TABLE 2

| Ref. | |
|---|---|
| No. | Part |
| 301 | Four (4) mass comparators |
| 302 | Anti-vibration table |
| 303 | Chamber |
| 304 | Four (4) core holders |
| 305 | Four (4) pressure sensors |
| 306 | Valves |
| 307 | Vacuum pump |
| 308 | Pump |
| 309 | Booster pump |
| 310 | Gas cylinder |
| 311(a) | Data acquisition box |
| 311(b) | Computer and monitors |
| 312 | Hooks or insulated cables or wires |
| 313 | Draft shields |
| 314 | Ports |
| 315 | Resistance temperature detector, |
| | RTD |
| 316 | Thermocouple and/or RTD wires |
| 317 | Flexible lines (high temperature |
| | tubing) |
| 318 | Solid lines (for example, Hastelloy |
| | or steel tubes) |
| 319 | Electrical wire |
| 320 | Controller |

The gravimetric nanocondensation apparatus 300 utilizes high resolution and a large maximum load to study capillary condensation at reservoir conditions. Accordingly, the gravimetric nanocondensation apparatus 300 may include a mass comparator 301. The mass comparator is a gravimetric apparatus used to measure the amount of fluid adsorbed or desorbed. Unlike traditional balances which have insufficient capacity and resolution, mass comparators weigh by difference, enabling high resolution with large maximum loads. The mass comparator 301 may include a high capacity mass comparator. The mass comparator 301 may be operationally connected to the exterior of the core holder 304. Accordingly, the mass comparator 301 may be configured to sense changes in the total mass of the core holder 304. In particular, the core holder 304 may be mechanically suspended from the mass comparator 301 (mass balance) through one or more connection components such as wires, ropes, rods, or hooks (e.g., hooks or insulated cables 312), allowing the mass comparator 301 to directly sense any changes in the total mass of the core holder 304.

Suitable mass comparators may include, for example, a Mettler Toledo XPE505C mass comparator, which has a resolution of 0.01 milligrams even at its maximum load of 520 grams. As shown in FIG. 3, the mass comparator 301 may be placed on top of an anti-vibration table 302 and positioned outside of the chamber 303 (such as an environmental chamber). Such a configuration may serve to protect a mass comparator's sensitive electronics in experiments carried out at extreme conditions (for example, reservoir temperatures and reservoir pressures). Other protective measures may include containing experimental gases within high pressure, high temperature tubing and a core holder 304, which houses the adsorbent. An adsorbent hangs inside the chamber 303 from a hook or insulated cable 312 (or wire) on the bottom of the mass comparator.

The core holder 304 may be selected from: (a) a core holder comprising a body, endcaps, a hanging plate, micro-filters, compression fittings, and a modified compression spring; (b) a core holder comprising a body, endcaps, a hanging plate filters, compression fittings, a modified compression spring, and a flexible cylinder encapsulated inside the body of the core holder; (c) a core holder comprising a body, endcaps, a hanging plate filters, compression fittings, a modified compression spring, and spacers attached to the endcaps; and (d) a core holder comprising a body, endcaps, a hanging plate, micro-filters, compression fittings, a modified compression spring, a sleeve on the outside of the core body, and a hand crank on the surface of the sleeve.

Use of a high capacity mass comparator enables introduction of fluid to the core holder via flexible lines 317 (inside the chamber 303) and lines 318 (outside the chamber 303) to allow for the forced flow of fluids through the core holder 304. As a result, investigations of both single-component and multicomponent fluids in both static and flow-through measurements may be conducted. Flexible lines 317 may be made of high pressure, high temperature tubing. Lines 318 may be made of any suitable material such as Hastelloy or steel.

Mass comparators have a specific window of operating temperatures. For example, the minimum and maximum operating temperatures of the Mettler Toledo XPE505C mass comparator are 10° C. and 30° C., respectively. Accordingly, precautions may be taken to protect the mass comparator's sensitive electronics in experiments carried out at extreme conditions (for example, reservoir temperatures and reservoir pressures). These precautions include placing the mass comparator 301 on top of the chamber 303 while hanging an adsorbent inside the chamber 303 from a hook or insulated cable 312 (or wire) on the bottom of the mass comparator 301. The precautions may also include containing experimental pressures within high pressure, high temperature tubing (for example, flexible lines 317) and the core holder 304, which houses the adsorbent.

The gravimetric nanocondensation apparatus 300 may include more than one mass comparator and more than one core holder, wherein the core holders are all the same type of core holder. Additionally, or alternatively, gravimetric nanocondensation apparatus 300 may include more than one mass comparator and more than one core holder, wherein the core holders are different types of core holders.

The gravimetric nanocondensation apparatus may include more than one mass comparator 301 and more than one core holder 304. The gravimetric nanocondensation apparatus may include more than one mass comparator and more than one core holder, wherein the number of core holders is the same as the number of mass comparators. The gravimetric nanocondensation apparatus may include more than one mass comparator and more than one core holder, wherein each core holder is connected to one of the mass comparators via a hook or insulated cable or wire. The gravimetric nanocondensation apparatus may include between 2 and 10 mass comparators and between 2 and 10 core holders. For example, the gravimetric nanocondensation apparatus includes 4 mass comparators and 4 core holders.

The chamber 303 (for example, an environmental chamber) is used to ensure precise temperature control of the gravimetric nanocondensation apparatus 300 by use of a control unit (not shown) to control operation of the chamber 303. The chamber may include a heating element, a cooling element, and a temperature sensor. The chamber can further include an atmospheric purge mechanism configured to purge the interior of the chamber 303 of, e.g., oxygen. The chamber 303 comes equipped with the automated purge mechanism. A source of non-reactive gas can be in selective fluid communication with the interior of the chamber 303.

The chamber 303 of the gravimetric nanocondensation apparatus may be a Thermotron XSE-600-3-3-MS environmental chamber. The chamber 303 may have an operating temperature range from about −100° C. to about 232° C. The operating pressure of the chamber 303 may range from vacuum to about 10,000 psi. The chamber 303 may be customized to interface with at least four resistance temperature detectors (RTDs 315) and at least two thermocouples. The chamber 303 may be customized to include ports on both the sides and on top of the chamber 303. Including ports on both the sides and on top of the chamber 303 may be useful to pass lines and wires into and out of the chamber 303, including the hook or insulated cable 312 (or wire) suspending the core holder 304 from the mass comparator 301. For example, thermocouple and/or RTD wires 316 may be positioned inside the chamber 303 and the RTD 315 may be placed outside the chamber 303. The ports may also be useful to anchor a draft shield 313, which may be fastened around the core holder 304 to prevent air currents in the chamber 303 from impairing the resolution of the mass comparator 301. In FIG. 3, the ports 314 are shown as only being on top of the chamber 303, but as described, additional ports may be utilized.

In addition, the chamber 303 may be purged with an inert gas (for example, gaseous nitrogen). Purging the chamber 303 with an inert gas increases the safety of high-pressure, high-temperature reservoir condition experiments. Also, purging the chamber 303 with an inert gas may help prevent ice formation during low temperature experiments. The inert gas may be stored in a gas cylinder positioned outside of the chamber 303.

The gravimetric nanocondensation apparatus 300 further include a pump 308 for injecting adsorbate gas and to pressurize fluids under study. The pump 308 may be a dual cylinder pump, such as such as a dual cylinder Q5000 Quizix pump or dual cylinder Q6000 Quizix pump. The pump 308 for injecting adsorbate gas and to pressurize fluids may be housed outside the chamber 303. Additionally, or alternatively, the pump 308 for injecting adsorbate gas and to pressurize fluids may be housed inside the chamber 303. Pumps that may be housed outside the chamber may include a dual cylinder Q6000 Quizix Pump, which has a maximum pressure of about 10,000 psi (about 69 MPa). Pumps for injecting adsorbate gas that may be housed inside the chamber 303 may include a dual cylinder Q5000 Quizix Pump. Housing of the pump for injecting adsorbate gas inside or outside of the chamber 303 may be based on the size of the pump for injecting adsorbate gas or the maximum operating temperature of the pump. Q5000 Quizix pumps are smaller than Q6000 pumps. If the pump 308 has a high maximum operating temperature, it may be housed outside of the chamber 303. For example, the dual cylinder Q6000 Quizix pump has a maximum operating temperature of 160° C. and was housed outside of the chamber 303. Other pumps may have lower or higher maximum operating temperatures and may be housed either outside or inside of the chamber 303. The adsorbate gas may be stored in a gas cylinder 310 positioned outside of the chamber 303 and filtered through a gas dryer (not shown) prior to entering the chamber 303. An optional booster pump 309 may be utilized to increase pressure of the gas exiting the gas cylinder 310.

In static experiments, both cylinders of the pump 308 may be used to pressurize fluids. In experiments that utilize the injection of pre-heated fluids, heating tape may be used to heat the cylinders of the pump 308. The use of heating tape serves as an alternative to housing the cylinders of the pump 308 inside of the chamber 303.

The gravimetric nanocondensation apparatus 300 may further include a vacuum pump 307 (or rotary vacuum pump) which may be housed outside the chamber 303. The vacuum pump 307, such as a hydrocarbon-free turbomolecular pump, may be used to vacuum out the apparatus and de-gas the adsorbent. A hydrocarbon-free turbomolecular pump has magnetic bearings instead of oil-lubricated bearings. Consequently, lubricant fumes do not adsorb to tubing during vacuuming. Hydrocarbon-free turbomolecular pumps may achieve vacuum levels of at least 10⁻⁶ mbar.

Valve 306 may be coupled to the core holder 304, the gas cylinder 310 (or gas tank), and the vacuum pump 307 (or vacuum source) by lines, piping, or tubing as shown in FIG. 3. The valves may be configured to control the flow of, for example, gas and vacuum through various portions of the gravimetric nanocondensation apparatus 300. The valve 306 may be three-way valves. The valve 306 may be configured to control the pressure within the core holder 304. The valve 306 may be an automated valve. The valve 306 may be a remotely actuated valve, such as a remotely actuated three-way valve.

The valve 306 may free the gravimetric nanocondensation apparatus 300 of manual actuation, enabling remote and automatic injection and/or suction of fluids. The valve 306 may also enable selective fluid communication of vacuum, gas, and/or pressure with the core holder 304. In FIG. 2, electrical wire or connection is indicated by the dashed lines while gas and vacuum lines are indicated by the solid lines. Instead of electrical wire and connection, transmitters and receivers may be used to send signals to various components of the gravimetric nanocondensation apparatus 300. Any suitable valve may be utilized such as those commercially available from Vindum Engineering, Inc.

The gravimetric nanocondensation apparatus 300 may further include a pressure sensor 305 (such as pressure transducer). The pressure sensor 305 may be operationally connected to the interior of the core holder 304. The pressure sensor 305 may be configured to sense the pressure inside or within the core holder 304 and produce a pressure signal.

The gravimetric nanocondensation apparatus 300 may further include a pressure and flow control system that generally includes a pressure source in selective fluid communication with the core holders 304, an automated pressure valve (for example, valve 306) configured to control pressure within the core holder 304, and a controller/processor. The controller/processor, further described below, may execute instructions of algorithms described herein. The gravimetric nanocondensation apparatus 300 may further include an automated vacuum valve (for example, valve 306) configured to control pressure within the core holder 304. The automated vacuum valve (for example, valve 306) can be coupled to the vacuum pump 307 and to the core holder 304.

As described, the valve 306 may have multiple functions, for example, controlling the pressure within the core holder 304. The valve 306 may be in selective communication with the pressure source. The valve 306 may be in selective communication with the vacuum source (for example, vacuum pump 307). The valve 306 is also referred to as an automated valve. In the illustrated embodiment, the valve 306 may be a constant volume, remotely actuated three-way valve, however, other valves are contemplated. The valve 306 may be a rapid open/close valve wherein opening or closing may be completed in, for example, approximately 0.1 seconds, though other values are contemplated. The valve 306 may be actuated using compressed air supplied at, for example, 70-100 psi, via a solenoid pilot valve (12V or 24V). That is, the electrical wire 319 coupled between the controller 320 and the valve 306 in FIG. 3 may, in some embodiments, be an air line. Having the option of electrical wire and an air line allows the signal between the controller 320 and the valve 306 to be an electrical signal or an air signal.

The gravimetric nanocondensation apparatus 300 may further include a data acquisition and remote control unit which may include a data acquisition box 311(a), a computer 311(b) and monitors, and a controller 320. The pressure sensors 305 (such as pressure transducers) and differential mass balances (such as mass comparators 301) may feed measurement data into the data acquisition box 311(a). The computer 311(b) and monitors, for example, may be utilized to control the experiments and to view experimental results.

The controller 320 may be operably coupled to the valve 306 and the computer 311(b). The controller 320 may also be operably coupled to mass comparator(s), pressure sensor(s), pressure transducer(s), thermocouple(s), vacuum gauge(s), among other components.

The computer 311(b) may be utilized to send information, for example, commands, to the controller 320. The controller 320 may be utilized to control various components of the gravimetric nanocondensation apparatus 300 and to view experimental results. The controller 320 may be any suitable unit. The controller 320 may can include sensors to convert physical parameters to electrical signals; signal conditioning circuitry, to convert sensor signals into a form that can be converted to digital values; analog-to-digital converters, to convert conditioned sensor signals to digital values. Computer software associated with the controller 320 may process raw data from various components of the apparatus, such as a mass comparator, thermocouple(s), pressure transducer(s), vacuum gauge(s), among other components. A computer algorithm may be utilized to, for example, process the data from the data acquisition and remote control unit and the controller 320 and make decisions on remotely opening/closing valves, among other operations.

The gravimetric nanocondensation apparatus 300 may further include a controller 320. The controller 320 may be operationally connected, for example, by electrical wires 319 (indicated as dashed lines) to one or more elements in the gravimetric nanocondensation apparatus 300, such as valve 306, pressure sensor 305, mass comparator 301, RTD 315, and/or data acquisition box 311(a), among other elements. Although not shown in FIG. 3, each pressure sensor 305 may be coupled to the controller 320. The controller 320 may be configured to control the opening and closing of valves 306. The controller 320 may be configured to collect pressure data from the pressure sensors 305. The controller 320 may be configured to collect gravimetric data from the mass comparators 301. The controller 320 may be configured to collect temperature data from the RTD 315 and/or associated thermocouple or RTD wires. The controller 320 may be configured to collect pressure data at pump 308, at optional booster pump 309, at gas cylinder 310, and/or at vacuum pump 307.

The controller 320 may be operable to control one or more operations of the gravimetric nanocondensation apparatus 300 and/or methods described herein. The controller 320 may include one or more processors, memory, and support circuits. The processor may be one of any form of general purpose microprocessor, or a general purpose central processing unit (CPU), each of which may be used in an industrial setting, such as a programmable logic controller (PLC), supervisory control and data acquisition (SCADA) systems, or other suitable industrial controller.

The one or more processors of the controller 320 may execute instructions of algorithms described herein. The controller 320 (and/or associated processor) may be configured to perform one or more of the following operations: (a) control an automated pressure valve (for example, the valve 306) based at least in part on pressure signals from a pressure sensor (for example, the pressure sensor 305); (b) to step the pressure within the core holder 304 through a series of predetermined pressure set points; (c) to control the pressure within the core holder 304 to a predetermined pressure set point; (d) to analyze pressure signals for stationarity; (e) to open and/or close the automated pressure valve (for example, the valve 306) for a calculated period of time to control the pressure within the core holder 304 to a predetermined pressure set point; (f) to control an automated vacuum valve (e.g., the three-way valve 206); (g) to control the temperature within the chamber 303; (h) to control the atmosphere within the chamber 303 via an automated purge valve; (i) to automatically direct the contents of the core holder 304 into a gas chromatograph; (j) to automatically log data from the pressure sensor 305, the mass comparator 301, and other components; (k) to control the atmosphere within the chamber 303 via an automated purge valve coupled to the chamber 303. Although the one or more processors are discussed with reference to FIG. 3, the one or more processors can be used with other apparatus described herein, such as the apparatus of FIG. 2.

The memory of the controller 320 may be non-transitory and may be one or more of readily available memory such as random access memory (RAM), read only memory (ROM), or any other form of digital storage, local or remote. The memory contains instructions, that when executed by the processor, facilitates the operation of apparatus described herein and methods described herein. The instructions in the memory may be in the form of a program product such as a program that implements methods described herein. The program code of the program product may conform to any one of a number of different programming languages. Illustrative, but non-limiting, computer-readable storage media may include: (i) non-writable storage media (e.g., read-only memory devices within a computer such as CD-ROM disks readable by a CD-ROM drive, flash memory, ROM chips, or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of methods described herein, are examples of the present disclosure. In some embodiments, which may be combined with other embodiments, the disclosure may be implemented as the program product stored on a computer-readable storage media (e.g., memory) for use with the controller 320 and the computer 311(b). The program(s) of the program product may define functions of the disclosure, described herein. In the illustrated embodiment of FIG. 3, a fluid-solid system may be tested across a series of pressure, temperature, and or density ranges or points in order to characterize a particular fluid-solid system. For example, a porous rock sample may be placed in the core holder 304 and a gaseous fluid may be introduced to the porous sample in core holder via gas cylinder 310, thereby creating a fluid-solid system. At least a portion of the gaseous fluid may condense in and/or on the porous rock sample, as detected by the mass comparator 301.

The controller 320 may be configured to automatically adjust temperature and/or pressure of the fluid-solid system to a preselected value. For example, the pressure of the fluid-solid system may be controlled by actuating the valve 306 to increase pressure via the gas cylinder 310 or decrease pressure via the vacuum pump 307 via use of the controller 320. The controller 320 may be configured to automatically monitor the fluid-solid system for equilibrium via, for example, the pressure sensor 305. The controller 320 may be configured to automatically record a value for temperature, pressure, mass, or combinations thereof of the fluid-solid system. The controller 320 may then direct the apparatus to adjust the pressure and/or temperature inside the core holder 304.

The controller 320 may be configured to cause flow of the adsorbate gas from the pump 308 and into the core holder 304 to contact the nanoporous material by opening the valve 306. The controller 320 may be configured to cause collection of adsorption data, desorption data, or combinations thereof, the adsorption data and desorption data comprising gravimetric data by logging data from the pressure sensor 305 and the mass comparator 301.

For characterization of liquid-solid systems, the porous material may be pre-saturated with a liquid prior to placing the pre-saturated porous material into core holder 304. Additionally, or alternatively, existing lines (such as flexible lines 317 and lines 318) and pumps (such as pump 308) or separate lines with separate pumps may be utilized to inject liquids into the core holder 304 to saturate the porous material.

Beyond automation, the gravimetric nanocondensation apparatus 300 may maintain a variety of fluids at specific temperatures (for example, temperatures in a range from −100° C. to 232° C.) and pressures (for example, pressures in a range from vacuum to about 10,000 psi, such as from about 0 psi to about 2,000 psi, such as from about 0 psi to about 1,500 psi). The gravimetric nanocondensation apparatus 300 may have the capability to simulate overburden pressure. Consequently, the gravimetric nanocondensation apparatus 300 may be used to study interactions between fluids and solids, including adsorption, desorption, and nanocondensation (also known as “capillary condensation”). In particular, the gravimetric nanocondensation apparatus 300 may be used to re-create reservoir conditions during capillary condensation measurements. Further, the gravimetric nanocondensation apparatus 300 may be used to achieve the temperatures and pressures necessary to study single-component fluids in a variety of adsorbent pore types.

Although not shown in FIG. 3, the gravimetric nanocondensation apparatus 300 may further include a gas chromatograph, such as an Agilent 7890B gas chromatograph. The gas chromatograph may be coupled to the apparatus as described herein with respect to FIG. 2. The gas chromatograph may be customized to be capable of Detailed Hydrocarbon Analysis. The gas chromatograph may be customized to be capable of Simulated Distillation. The gas chromatograph may be customized to be capable of analyzing fixed gases. The gas chromatograph may be utilized to measure the composition of bulk fluid, the composition of confined fluid, or combinations thereof. The gas chromatograph may be made out of a highly corrosion-resistant metal alloy. The gas chromatograph may be fitted with a high-pressure gas inlet valve. The gas chromatograph may be fitted with heated tubing and/or a heated gas inlet valve.

### Methods

Embodiments of the present disclosure also generally relate to methods for characterizing porous materials, such as nanoporous materials, and fluid-solid systems. Embodiments described herein utilize a novel gravimetric method for accurately characterizing nanoporous materials by estimating various characteristics (quantitative and/or qualitative) of the nanoporous materials such as specific surface area, pore size, pore size distribution, specific pore volume, or combinations thereof using any suitable theoretical method such as BET, BJH, DFT, NLDFT, among other theoretical methods.

Methods of the present disclosure may be performed using any suitable apparatus, such as those apparatus 200, 300 described herein. Methods described herein may generally include placing an adsorbent in a core holder, setting a temperature and pressure, and measuring a change in mass in the fluid with a mass comparator.

Methods described herein may generally include one or more of the following operations: placing a nanoporous material in a core holder of a characterization apparatus; introducing a fluid (for example, an aqueous fluid, a hydrocarbon, a gas, or combinations thereof) to establish a fluid-solid system within the core holder; adjusting the fluid-solid system's temperature to a predetermined temperature value, the fluid-solid system's pressure to a predetermined value, or combinations thereof using a processor and one or more automated valves; monitoring the fluid-solid system until equilibrium is reached; recording and collecting gravimetric data (for example, a temperature, a pressure, a mass data, or combinations thereof) of the fluid-solid system; converting the gravimetric data to volumetric data; and obtaining the corresponding characteristic parameters by analyzing the converted volumetric data. Analyzing the converted volumetric data may include quantifying various pore characteristics and/or determining qualitative characteristics of pores.

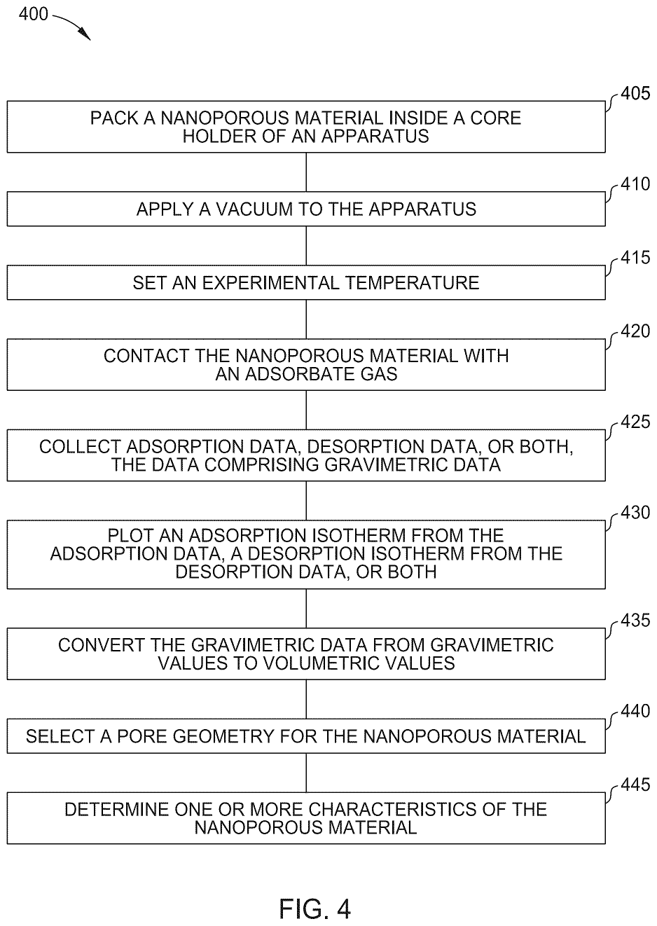

FIG. 4 shows non-limiting operations of a method 400 for characterizing a porous material, for example, a nanoporous material, according to at least one embodiment. The method 400 may be characterized as a pore characterization algorithm. The method 400 may be performed using apparatus 200 or gravimetric nanocondensation apparatus 300. As described herein, the controller 320 may facilitate one or more operations of the method 400.

The method 400 may include disposing a porous material inside a core holder of an apparatus at operation 405. Here, for example, the porous material may be packed, placed, or otherwise disposed inside of core holder 304 of gravimetric nanocondensation apparatus 300. Disposing the porous material inside the core holder at operation 405 may include one or more of the following: placing micro-filters at the ends of a core holder to prevent material escaping from the holder; weighing the core holder before and after the packing to determine the actual weight of the sample; tightening and sealing the core holder; connecting the core holder with the apparatus tubing; hanging the core holders with the cables to the mass balances; or combinations thereof.

The method 400 may further include applying a vacuum to the apparatus or to components of the apparatus at operation 410. Application of the vacuum at operation (b) facilitates removal of moisture or pre-adsorbed gases from the sample. For example, vacuum pump 307 may be used to remove moisture and/or pre-adsorbed gas(es), from component(s) of apparatus and/or the porous material.

The method 400 may further include setting an experimental temperature for the characterization at operation 415. For example, a desired temperature may be input to a control panel of the chamber 303 that houses the core holder 304. The temperature may be set to any suitable temperature, such as a temperature in a range from about −100° C. to about 232° C. The chamber 303 may use feedback from a thermocouple and/or RTD wires 316, the RTD 315, or combinations thereof for temperature adjustment.

The method 400 may further include contacting the porous material with an adsorbate gas at operation 420. This initiates the experiment. Operation 420 may include injecting an adsorbate gas into the core holder by opening desired valves such that the adsorbate gas flows into the core holder and contacts the porous material. Pressures, temperatures, or both may be adjusted to predetermined values during operation 420. For example, adsorbate gas may be flowed from gas cylinder 310 through pump 308, valve 306, and into the core holder 304 where it contacts the sample (e.g., porous material). Operation 420 may include opening valve 306, adjusting pressures and/or temperatures to desired values, or combinations thereof. Operation 420 may be performed manually or automatically.

The method 400 may further include collecting, or acquiring, experimental data at operation 425. The collection of data at operation 425 may be performed by recording adsorption data, desorption data, or combinations thereof. Experimental data may include adsorption data, desorption data, or both. Here, for example, data may be collected using data acquisition box 311(a). Such data collected by the data acquisition box 311(a) may include gravimetric data from the mass comparators 301, pressure data from the pressure sensors 305, temperature data from the thermocouple and/or RTD wires 316, or combinations thereof. The data collected at operation 425, for example, includes gravimetric data from the mass comparator 301 and pressure readings from the pressure sensor 305. The data collected at operation 425 may optionally further include temperature readings from the thermocouple and/or RTD wires 316, depending on the operating mode, for example, temperature data at constant pressure.

The method 400 may further include plotting an adsorption isotherm, a desorption isotherm, or both from the experimental data at operation 430. Here, for example, the adsorption data may be utilized to plot an adsorption isotherm and the desorption data may be utilized to plot a desorption isotherm. Plotting of the isotherm(s) may be performed utilizing any suitable computer program stored on computer 311(b).

The method 400 may further include converting the gravimetric data from gravimetric values to volumetric values at operation 435. The conversion of the gravimetric values to volumetric values at operation 435 may be performed using conversion factors, for example, gas density at standard temperature and pressure recommended by International Union of Pure and Applied Chemistry (IUPAC) and International Organization of Standardization (ISO). For example, the conversion process at operation 435 may be performed using any suitable equation, such as Eq. 1(a), described below. The absolute pressure of the adsorbed gas may also be converted into a relative pressure of the adsorbed gas by normalizing it with the saturation pressure of the adsorbate gas at the experimental temperature using any suitable equation, for example, Eq. 1(b), described below.

The method 400 may further include selecting a pore geometry for the porous material at operation 440. Pore geometry generally refers to the shape and arrangement of pores within the porous material. Pore geometry may be, for example, cylindrical, spherical, cubic, or combinations thereof, among other pore geometries. The pore geometry may be ascertained from geometric information of the porous material to be characterized. For example, pores of MCM-41 nanoporous material may be assumed to be cylindrical in shape due to its hexagonal pores or semicylindrical structure of pores.

The method 400 may further include determining one or more characteristics of the porous material at operation 445. Here, for example, various characteristics such as surface area, pore size, pore size distribution (PSD), pore volume, or combinations thereof, among other characteristics, may be determined using any suitable method. Suitable methods may include, but are not limited to, BET, BJH, DFT, NLDFT, or combinations thereof. The determination process of operation 445 is further described herein, and illustrative, but non-limiting, examples of equations for determining characteristics of the porous material at operation 445 are described herein.

The method 400 may optionally include selecting the adsorption isotherm or the desorption isotherm after operation 430 and before operation 435. This operation may be performed using the computer 311(b). Selection of the adsorption or desorption isotherm at may be based on the type of material being investigated, experimental conditions (for example, temperature and/or pressure under which the experiment is conducted), or combinations thereof. The adsorption isotherm and desorption isotherm includes gravimetric data gathered by the experiment.

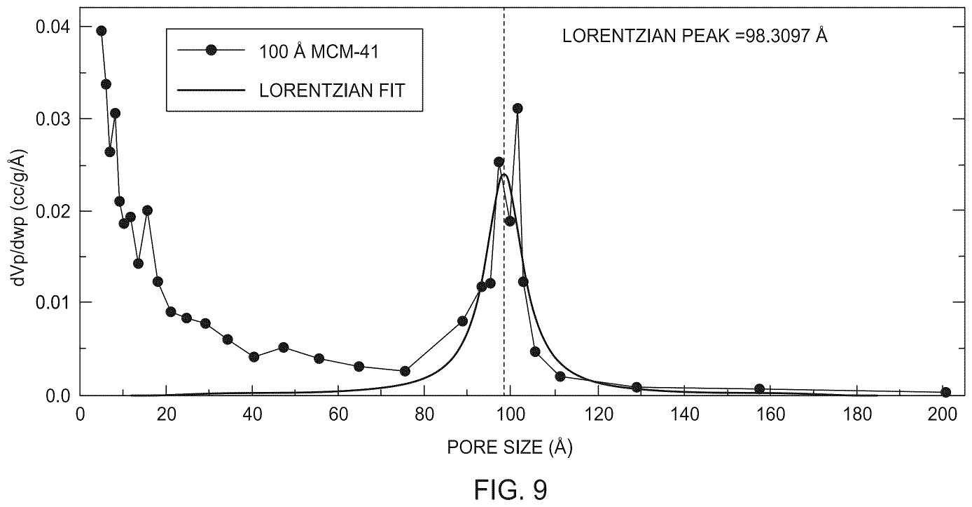

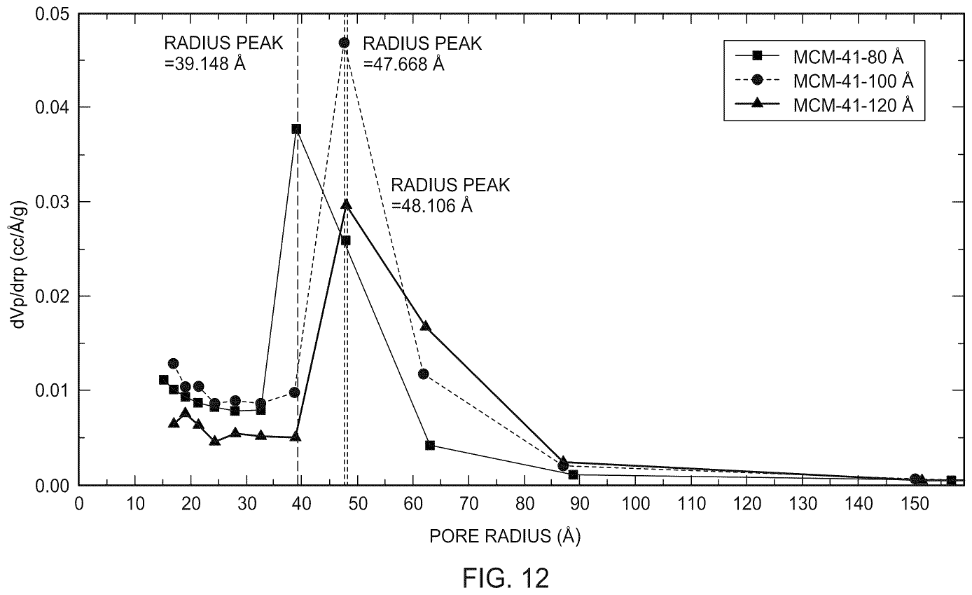

To the inventors' knowledge, at least operations 425 and 435 are not performed with state-of-the-art technologies. For example, conventional technologies collect volumetric data or indirect gravimetric values during adsorption and desorption without directly determining gravimetric values. By directly determining gravimetric values, embodiments described herein provide more accurate, reliable, and reproducible characterization data without the need to use equations of state (in conventional volumetric methods) or buoyancy corrections (in conventional gravimetric methods). The higher accuracy and reproducible data may be due to the determination of more data points by embodiments described herein. For example, FIGS. 9-11 show data using embodiments of the present disclosure, and the data includes at least 10 data points. In contrast, conventional methods produce data such as the data shown in FIG. 12, which shows only three data points. In addition, the more data points determined by use of embodiments described herein permits better control over the resolution of the data.

In practice, for example, after completing operations 405-420 of method 400, data collection is started at operation 425. Here, for example, components of the gravimetric nanocondensation apparatus 300 may inject pulses of adsorbate gas and the gravimetric nanocondensation apparatus 300 reaches equilibrium, and components of the apparatus record the adsorbed mass and its associated pressure at operation 425. The recorded data may be plotted to provide adsorption/desorption isotherms at operation 430. The adsorption isotherm or desorption isotherm may be selected. The adsorption isotherm may be selected, for example, when the adsorption and desorption curves are reversible (follow the same path). Additionally, or alternatively, the desorption isotherm may be selected. Conversion of the gravimetric values to volumetric values at operation 435 may then be performed, followed by selecting a pore geometry at operation 440, and determining one or more characteristics of the porous material at operation 445.

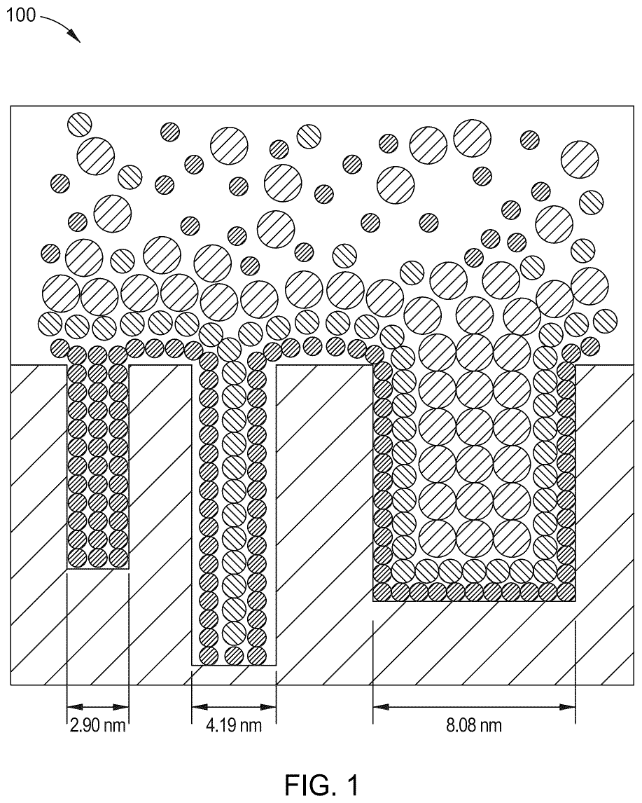

Embodiments described herein are applicable to porous materials of any suitable type using various adsorbate gases such as carbon dioxide (CO₂), nitrogen (N₂), hydrocarbons (for example, ethane (C₂H₆) and methane (CH₄)), natural gas, hydrogen (H₂), helium (He), or combinations thereof. Embodiments described herein may be used to generate adsorption and desorption isotherms utilizing mass comparators, core holders, a chamber, and pumps. Such equipment may ensure high precision and accuracy in the measurements. Unlike conventional technologies, embodiments of the present disclosure enable the characterization of nanoporous materials using different types of adsorbates such as H₂, He, CO₂, N₂, hydrocarbons, natural gas, or combinations thereof, enabling comprehensive analysis of material properties across various applications and research domains. FIG. 1 shows an illustration 100 of various molecules, for example, hydrocarbons, N₂, H₂, in a nanoporous space. Unlike conventional techniques which utilize large nitrogen molecules only, embodiments described herein may utilize smaller atoms or molecules such as CO₂, H₂, He, or combinations thereof. The smaller atoms or molecules may enter the smaller pores of porous materials where larger molecules or atoms cannot.

In contrast to conventional technologies, embodiments described herein eliminate errors inherent with traditional methods through the use of high-precision balances, ensuring reliable estimation of, one or more of the characteristics of the nanoporous material. Embodiments of the present disclosure are also compatible with a wide range of temperatures and pressures, enabling characterization of nanoporous materials under various environmental conditions to capture their diverse properties. Overall, embodiments of the present disclosure may be utilized to provide tailored nanoporous material characterization, enabling robust and efficient tools for nanoscience and nanotechnology research and development.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### EXAMPLES

Although various equations in the Examples section are described with reference to a specific adsorbate gas, the equations may be used for any suitable adsorbate gas such as those described herein. Methods and apparatus described herein may be used for any suitable adsorbate fluid, e.g., an adsorbate gas or an adsorbate liquid. Accordingly, reference to “adsorbate gas” may be interchangeably used with “adsorbate fluid.”

In this disclosure, an objective is to present a novel gravimetric method as a tool for nanoporous material characterization. Gravimetric methods described herein enable characterization of a nanoporous material, for example: measurement of the SSA of porous material (for example, by the BET method); measurement of the SSA of a porous material (for example, by the BJH method); measurement of the SPV of a pore of a porous material (for example, by the BJH method); measurement of a pore size and pore size distribution of a porous material (for example, by the BJH method); among others characterizations.

Gravimetric methods described herein, such as method 400, were performed to characterize a porous material. The method was performed using gravimetric nanocondensation apparatus 300, though apparatus 200 may be utilized.

The porous material was packed inside a core holder and the vacuum was turned on to remove moisture and pre-adsorbed gas(es), if any, from the porous material. The temperature was set by use of the chamber. Adsorbate gas was flowed into the core holder which initiated the experiment. Data collection was started. The system was allowed to establish equilibrium, and the adsorbed mass and its associate pressure was recorded. The recorded data was plotted to provide adsorption isotherms and desorption isotherms.

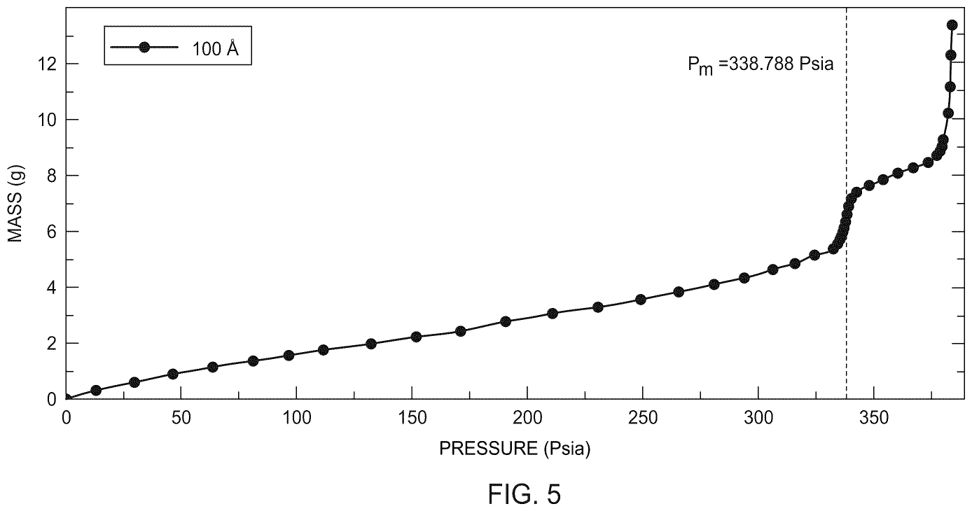

FIG. 5 is a plot showing the absolute adsorbed mass versus absolute pressure, which is a gravimetric isotherm, for the MCM-41 sample with a pore size of 100 angstroms (Å). The data acquired by the gravimetric nanocondensation apparatus 300 is gravimetric (mass in grams, pressure in absolute pressure (psia)). In FIG. 5, Pₘ refers to the capillary condensation pressure and the vertical dashed line refers to capillary condensation relative pressure. Pₘ is utilized in determining the pore size of the material. In this example, Pₘ was determined to be about 338.788 psia.

The recorded gravimetric data shown in FIG. 5 was then converted to volumetric data by utilizing conversion factors in order to implement the available theoretical methods of characterization. Here, Eq. 1(a) was utilized to convert the absolute adsorbed mass into adsorbed volume (cubic centimeters per gram, cc/g) at standard temperature and pressure conditions (STP, 0° C. and 1.01 bar) used in this determination.

Vol. of adsorbate gas adsorbed=mass of adsorbate gas adsorbed/Density of adsorbate gas at STP (Eq. 1(a))

“Vol.” in Eq. 1(a) refers to adsorbed volume, which is the volume of adsorbate gas adsorbed.

The absolute pressure of the adsorbed gas inside the core holder was also converted into a relative pressure of the adsorbed gas by normalizing it with a saturation pressure of the adsorbate gas at the experimental temperature using Eq. 1(b):

$$Relative pressure of absorbed gas = \frac{Absolute pressure of absorbed gas}{Saturation pressure of adsorbate gas} \qquad ( Eq . 1 ( b ) )$$

Relative pressure is also referred to as a P/Pₒ value. The saturation pressure (P₀) of the adsorbate gas may be obtained from a standards organization, for example, the National Institutes of Standards and Technology (NIST). The saturation pressure may also be measured during the experiment. The saturation pressure refers to the pressure at which the adsorbate gas begins to fully condense into a liquid phase within the system at a given temperature, marking the onset of bulk condensation. Specifically, the saturation pressure represents the equilibrium pressure at a given temperature where the adsorbate gas begins to condense into a liquid phase, even in the absence of any porous medium. At this pressure, the gas and liquid phases coexist under bulk conditions, marking the onset of bulk condensation. During this phase transition the pressure remains constant.

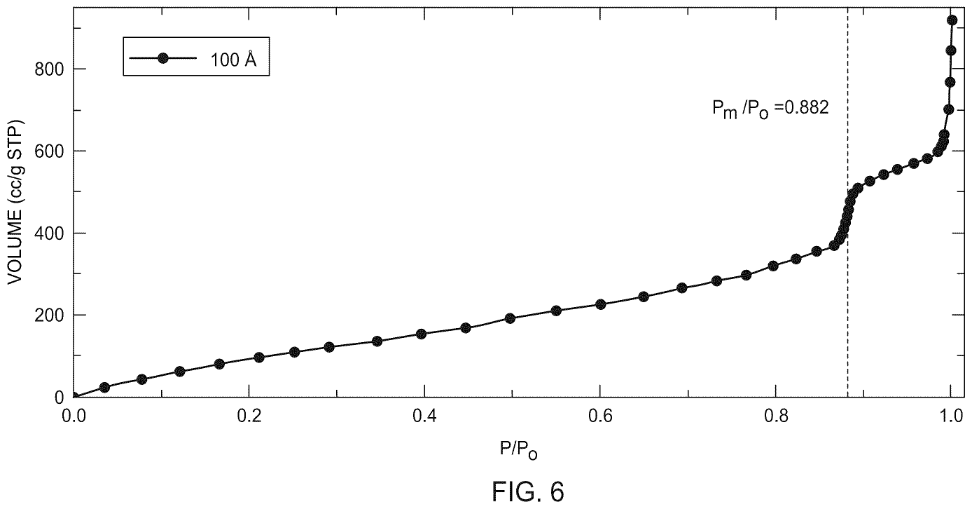

FIG. 6 shows a plot of adsorbed volume against the relative pressure of the MCM-41 sample with pore size of 100 Å. A Pₘ/Pₒ (capillary condensation relative pressure) value of about 0.882 was determined. Pₘ/Pₒ is the vertical dashed line in FIG. 6.

At operation 440, the pore geometry of the material MCM-41 was assumed as cylindrical in shape due to the hexagonal or semi-cylindrical structure of pores.

After operation 440, various characteristics of the nanoporous material were determined in operation 445 such as specific surface area, pore size, pore size distribution, and specific pore volume using any suitable method (e.g., BET, BJH, DFT, NLDFT, etc.). Determination of the characteristics is described in the following examples.

### Example 1: Specific Surface Area by BET Method

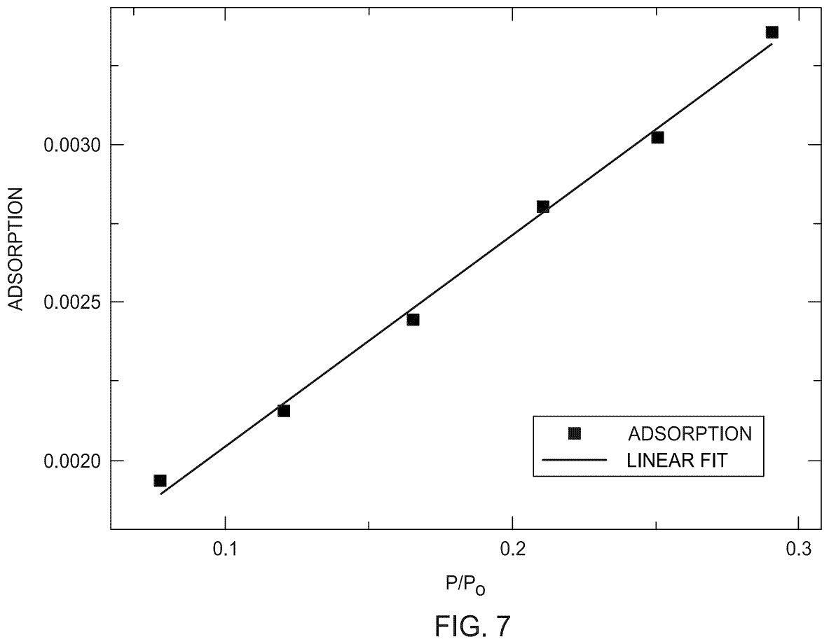

FIG. 7 shows a plot of adsorption versus relative pressure of MCM-41 (100 Å). The data in the plot shown in FIG. 7 was linearly fit with a linear equation, the parameters of which were used for determining BET surface area of MCM-41 (100 Å). Non-limiting parameters and data collected from the plot shown in FIG. 7 and calculations described in Example 1 are shown in Table 3.

TABLE 3

| Equation | y = b*x |
|---|---|
| Plot | Adsorption |
| Weight | No weighting |
| Intercept | 0.00138 ± 4.36359E−5 |
| Slope | 0.00669 ± 2.18327E−4 |
| Residual sum of squares | 6.1577E−9 |
| Pearson's r (correlation coefficient) | 0.99788 |
| R-square (coefficient of determination) | 0.99576 |
| Adjusted R-square | 0.9947 |

The BET method is a method for determining the specific surface area of a pore. According to the BET hypothesis, adsorption energy is constant for all adsorption sites, with little lateral interactions between nearby adsorbed molecules and gas molecules interacting vertically. Therefore, the BET method is implemented on a certain range (for example, 0.05 to 0.35) of relative pressure in the adsorption isotherm (data from operation 435). The following operations (1-1) through (1-6) present an algorithm to implement the BET method:

Operation (1-1): Plot the straight line according to Eq. 2(a):

$$\frac{P}{{V}_{ads} ( {P}_{o} - P )} = \frac{1}{{V}_{m} * C} + \frac{C - 1}{{V}_{m} * C} \frac{P}{{P}_{o}} \qquad ( Eq . 2 ( a ) )$$

The first layer of adsorbate is governed by Eq. 2(a). In Eq. 2(a), Vₘ refers to monolayer volume, which is the volume of adsorbate needed on a given sample in order to generate a complete monolayer that is adsorbed; C refers to a constant that represents the difference in the heat adsorption between the first layer and the succeeding layers; P is experiment pressure; and Pₒ is saturation pressure. The experimental pressure (P) refers to the pressure at which the adsorbate gas is added to the core holder. The saturation pressure (P₀) refers to the saturation pressure of the adsorbate gas and may be obtained from a standards organization (for example, NIST). The saturation pressure may also be measured during the experiment.

Operation (1-2): From the plot was determined the intercept, I, according to Eq. 2 (b):

$$I = \frac{1}{{V}_{m} * C} \qquad ( Eq . 2 ( b ) )$$

Operation (1-3): The slope, S, was determined according to Eq. 2(c):

$$S = \frac{C - 1}{{V}_{m} * C} \qquad ( Eq . 2 ( c ) )$$

Operation (1-4): From the intercept and the slope, the constant, C (unitless constant), was determined according to Eq. 2(d):

$$C = \frac{s}{I} + 1 \qquad ( Eq . 2 ( d ) )$$

Operation (1-5): Vₘ (monolayer volume) was then determined by inputting the values of S and I (which are determined graphically from the linear plot) into Eq. 2(b) and Eq. 2(c) to obtain the values of Vₘ. Here, once the value of S and I were found graphically, S and/may be utilized to find the value of C.

Operation (1-6): Then, Eq. 2(e) was utilized to determine the BET specific surface area:

$${S}_{BET} = \frac{{V}_{m} * {σ}_{m} * {N}_{A}}{{V}_{o} * m} * {M}_{{CO}_{2}} \qquad ( Eq . 2 ( e ) )$$

In Eq. 2(e), S_{BET} is BET specific surface area (square meters per gram, m²/g); σₘ is cross-sectional area of CO₂ molecule (square meters, m²); NA is Avogadro's number (6.023×10²³ molecules/mole); Vₒ is molar volume of CO₂ (cubic meters per mole, m³/mole) at STP; m is mass of the sample (grams, g) (in this example, the sample is MCM-41); and M_{CO}_{₂} is molar mass of CO₂ (g/mole). Although Eq. 2(e) is described with respect to CO₂, the equation is applicable to any suitable adsorbate gas such as those adsorbate gases described herein.

### Example 2: Specific Pore Volume (SPV), Specific Surface Area (SSA), and Pore Size Distribution by BJH Method

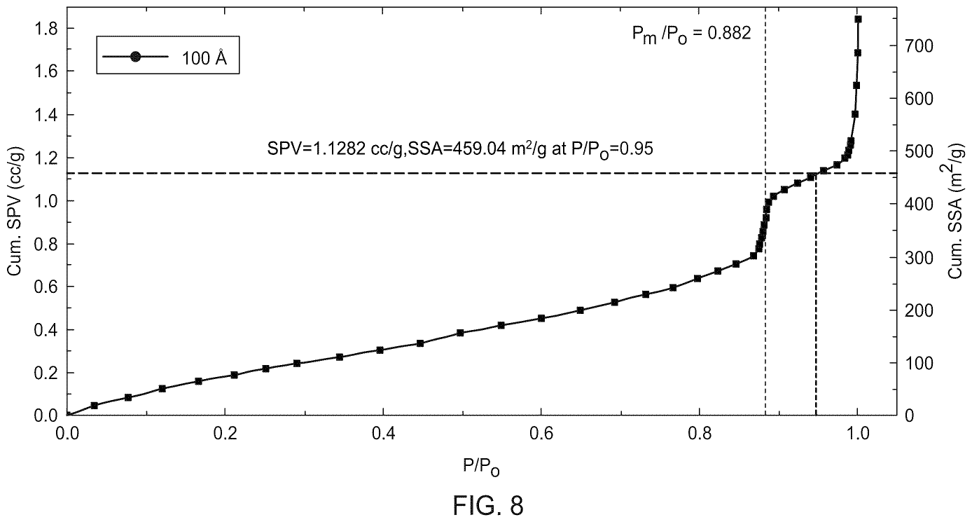

BJH is another method to determine the SPV and the SSA. Eq. 3(a) and Eq. 3(b), described below, was used to determine SPV and SSA, respectively. Also as the experimental data collection is a cumulative one, these two parameters were determined as cumulative measurements which is shown in FIG. 8. More specifically, FIG. 8 shows a plot of cumulative SPV and cumulative SSA were plotted against relative pressure (P/Pₒ) for MCM-41 (100 Å). The estimated values SPV and SSA were taken at a relative pressure of about 0.950. In the plot shown in FIG. 8, the vertical dashed line at a relative pressure of about 0.882 refers to capillary condensation relative pressure, the vertical dashed line at a relative pressure of about 0.95 refers to the relative pressure at which the values of SSA and SPV were determined. In this example, the cumulative (cum.) SPV was determined to be about 1.1282 cc/g and the cumulative SSA was determined to be about 459.04 m²/g.

The SPV was determined according to the BJH method by Eq. 3(a):

$$Specific pore volume ( SPV ) = \frac{{V}_{STP} * {M}_{{CO}_{2}}}{MV * {ρ}_{L}} \qquad ( Eq . 3 ( a ) )$$

In Eq. 3(a), V_{STP} is adsorbed volume of adsorbate gas (for example, CO₂) at standard temperature and pressure (0° C. and 1.01 bar); M_{CO}_{₂} is molar mass of adsorbate gas (for example, CO₂); ρ_{L} is liquid density (in this case, liquid density of the adsorbate gas (for example, CO₂) at experimental condition); and MV is molar volume of the adsorbate gas (for example, CO₂).

Here, the value of V_{STP} at the relative pressure (P/Pₒ) was taken and input into Eq. 3(a) to determine the SPV.

The SSA was determined according to the BJH method by Eq. 3(b):

$$BJH specific surface area ( SSA ) = 2 * \frac{{V}_{p}}{{r}_{p}} \qquad ( Eq . 3 ( b ) )$$

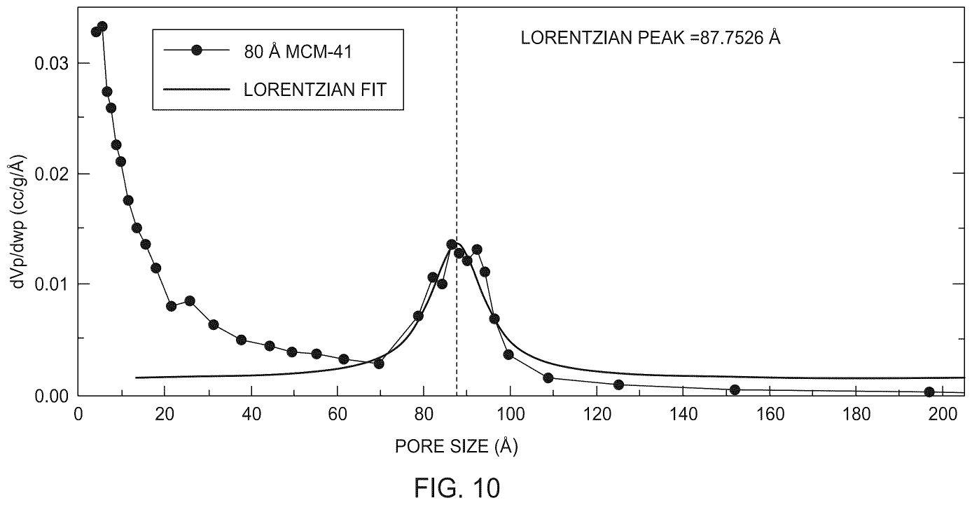

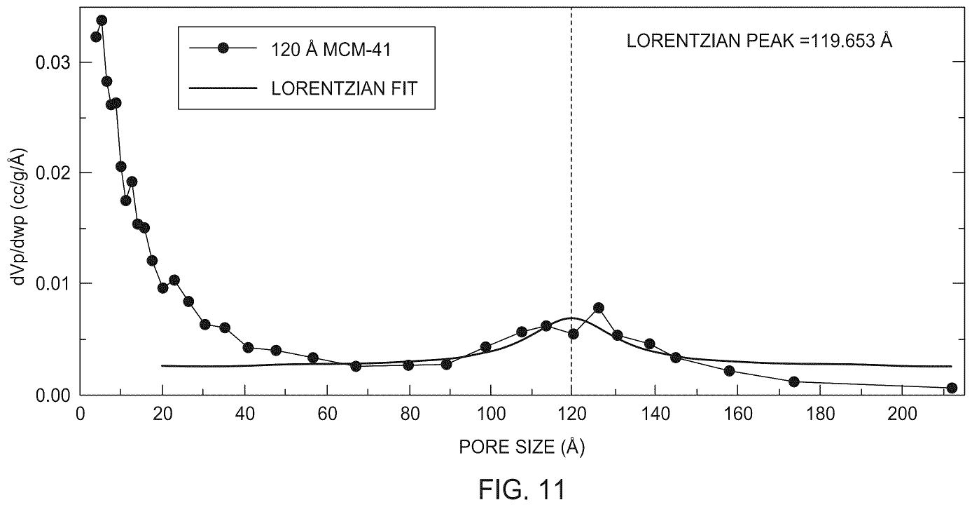

In Eq. 3(b), Vₚ is specific pore volume (SPV, as determined by Eq. 3(a)); and rₚ is corresponding radius of the pores. For example, rₚ is the pore radius determined from FIG. 9, FIG. 10 or FIG. 11 which is half of the pore size (pore diameter). The pore size is taken as the peak of the pore size distribution in FIG. 9, 10, or 11. FIGS. 9-11 are prepared using Eq.4 described herein.

Although Eqs. 3(a) and 3(b) were described with respect to CO₂, the equations are applicable to other suitable adsorbate gases, such as those adsorbate gases described herein.

BJH is one of the methods that may be utilized to determine the pore size distribution in a mesoporous material. As the MCM-41 sample of the study is mesoporous, the BJH method was implemented to determine the pore size distribution. The following operations (2-1)) through (2-3) present an algorithm to implement the BJH method to determine pore size distribution of a nanoporous material:

Operation (2-1): Utilizing the Kelvin equation shown in Eq. 4, the relative pressure of the adsorbed gas (e.g., CO₂) was converted into a Kelvin radius for adsorption isotherm or desorption isotherm:

$${r}_{k} = \frac{γ * {V}_{l}}{R * T * ln ( \frac{P}{{P}_{o}} )} \qquad ( Eq . 4 )$$

In Eq. 4, rₖ is Kelvin radius of the pores at the corresponding relative pressure of the adsorbed gas (for example, CO₂); γ is surface tension of the adsorbate gas (for example, CO₂); Vₗ is molar volume of the liquid adsorbate (for example, CO₂); R is universal gas constant (8.314 Joules per Kelvin per mole (J·K⁻¹·mol⁻¹)); T is Kelvin temperature (K); In is natural logarithm; and

$$\frac{P}{{P}_{o}}$$

is relative pressure of the adsorbed gas (for example, CO₂). Although Eq. 4 is described with respect to CO₂, the equation is applicable to any suitable adsorbate gas such as those adsorbate gases described herein. Liquid adsorbate is used because reference tables to look up the molar volume, Vₗ, have either vapor or liquid rather than the gas.

Operation (2-2): The corresponding Kelvin radius was then plotted with the volume of the adsorbate gas adsorbed (cc/g).

Operation (2-3): The differentiation of the adsorbed volume with respect to the pore size of the nanoporous material (dVp/dwp, in units of cc/g/Å) was plotted against the pore size of the nanoporous material to determine the pore size distribution of the nanoporous material. The data was fitted with a Lorentzian function to estimate or approximate the peak values. The pore size (also referred to as pore diameter) is equal to 2×Kelvin radius (i.e., 2×rₖ).

Operations (2-2) and (2-3) are sequential and conceptually linked steps in the determination of pore size distribution. In Operation (2-2), the Kelvin radius is calculated using the Kelvin equation from the equilibrium pressure data obtained during adsorption and then converted to pore size (pore diameter=2×Kelvin radius). The adsorbed volume corresponding to each equilibrium point is then plotted against the pore size, establishing a relationship between the volume of adsorbed gas and the effective pore dimensions. In Operation (2-3), this adsorption curve is numerically processed by differentiating the adsorbed volume with respect to pore size (dVp/dwp) to obtain the pore size distribution function. The resulting distribution shows how the total pore volume is distributed across different pore sizes. This differentiated data is then fitted with a Lorentzian function to identify and approximate the peak pore sizes that characterize the dominant pore structure of the material. The Lorentzian function is just one illustrative, but non-limiting, example of a function that may be used to determine the peak of a curve. Other functions are contemplated.

Overall, Eq. 4 is used to find the pore size of the nanoporous material in terms of Kelvin radius from the corresponding relative pressure values. The obtained Kelvin radius was plotted on the x-axis with the corresponding volume derivative on the y-axis (FIGS. 9-11). The corresponding Kelvin radius of the peak of that plot is the pore size.

The plots of pore size distribution as determined by the BJH method for the samples—MCM-41 (100 Å), MCM-41 (80 Å), and MCM-41 (120 Å)—under this study are shown in FIG. 9, FIG. 10, and FIG. 11, respectively.

Specifically, FIG. 9 shows the pore size distribution (dVp/dwp) for MCM-41 (100 Å) sample utilizing the BJH method with embodiments described herein. The Lorentzian function was fit to the curve to approximate the peak. The Lorentzian fit was utilized to estimate the Lorentzian peak which was estimated to be about 98.3097 Å. The pore size distribution of an MCM-41 (80 Å) sample utilizing the BJH method with embodiments described herein is shown in FIG. 10. The Lorentzian function was fit to the curve to approximate the peak. The Lorentzian fit was utilized to estimate the Lorentzian peak which was estimated to be about 87.7526 Å. FIG. 11 shows the pore size distribution of an MCM-41 (120 Å) sample utilizing the BJH method with embodiments described herein. The Lorentzian function was fit to the curve to approximate the peak. The Lorentzian fit was utilized to estimate the Lorentzian peak which was estimated to be about 119.653 Å.

FIG. 12 shows the pore size distribution for MCM-41 (80 Å), MCM-41 (100 Å) and MCM-41 (120 Å) samples using the conventional volumetric method of nitrogen sorption and reports the predicted pore radius for each material. Using the conventional nitrogen sorption method, the radius peak for MCM-41 (80 Å), MCM-41 (100 Å), and MCM-41 (120 Å) was determined to be about 39.148 Å, about 47.668 Å and about 48.106 Å, respectively. The conventional method utilizes the volumetric data which is calculated using equations of state and then the data is accumulated to perform the overall analysis. Then the conventional method applies the available theoretical methods such as BJH, BET, DFT to characterize the material. The use of equations of state in conventional methods is an indirect estimation of the values, leading to errors in the prediction of the adsorbed or desorbed volumes of the injected/retracted gases. Moreover, the error encountered during the data collection leads to accumulation of error in the overall characterization analysis. Additionally, the pressure range in the conventional method is very limited (from 0 psi to 14 psi) due to the use of nitrogen. For example, conventional methods cannot measure pore sizes greater than 120 Å because of the low nitrogen pressure. Therefore, the resolution of data points is less.

In contrast, embodiments of the present disclosure enable direct measurement the adsorbed/desorbed values using a high precision balance without the need of equations of state which reduces the error in in the overall characterization of the materials. Further, embodiments described herein work with wide range of gases with a large pressure range (for example, from 0 psi to about 2,000 psi), making it more versatile in recording data with higher resolution.

When applied to nanoporous material of wide ranges of pore sizes, conventional methods fail to provide consistent data. For example, and as shown in FIG. 12, the prediction of radius for the material MCM-41 (120 Å) by the conventional method is 48.106 Å which is 19.8133% error from the manufacturer values. However, for embodiments described herein, the prediction of radius is 59.8265 Å (FIG. 11) which is only 0.289% error. This indicates that the data collection in conventional method using volumetric method is less accurate than data collection using embodiments of the present disclosure.

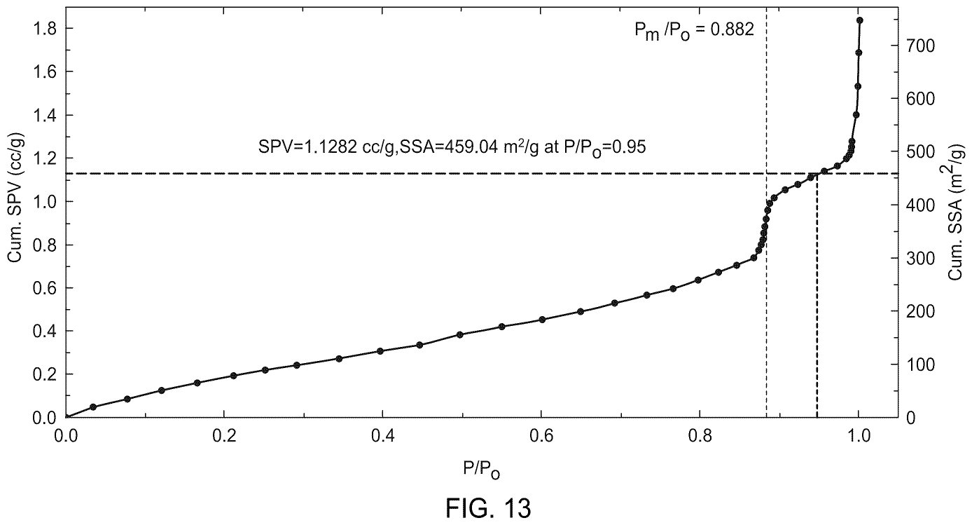

FIG. 13 shows SPV and SSA data for the MCM-41 (100 Å) sample using embodiments described herein. In the plot shown in FIG. 13, the vertical dashed line at a relative pressure of about 0.87 refers to capillary condensation relative pressure. The vertical dashed line at a relative pressure of about 0.95 refers to the pressure at which the SPV and SSA were determined. In this example, the cumulative SPV was determined to be about 1.282 cc/g, and the cumulative SSA was determined to be about 459.04 m²/g.

FIG. 13 was generated by converting the adsorbed volumes at STP (in FIG. 6) to specific adsorbed volume, SPV, through the use of Eq. 3(a) for each data point of FIG. 6. The generated data was plotted on the left-y-axis against the relative pressure on the x-axis. The SSA was obtained by converting the specific volume data (FIG. 13, left-y-axis) to SSA data using Eq. 3(b). The obtained data is presented on the right-y-axis for the same curve. Once this graph was generated, the SPV and SSA was obtained at any suitable relative pressure (e.g., 0.95) by drawing a vertical line from the specified relative pressure (e.g., 0.95) until it intersected with the isotherm curve. Then a horizontal line was drawn to determine the SPV and SSA values from the left-y-axis and right-y-axis, respectively.

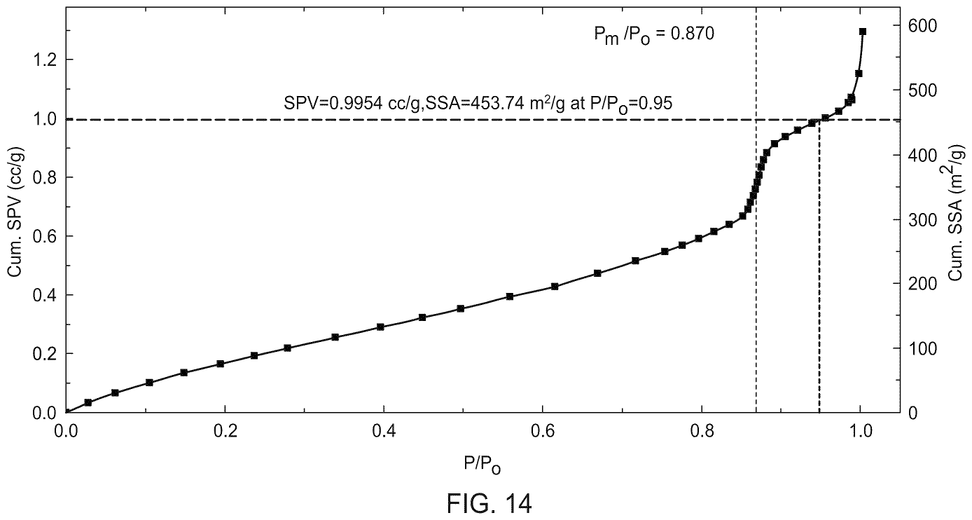

FIG. 14 shows SPV and SSA data for the MCM-41 (80 Å) sample using embodiments described herein. In the plot shown in FIG. 14, the vertical dashed line at a relative pressure of about 0.882 refers to capillary condensation relative pressure. The vertical dashed line at a relative pressure of about 0.95 refers to the pressure at which the SPV and SSA were determined. In this example, the cumulative SPV was determined to be about 0.9954 cc/g, and the cumulative SSA was determined to be about 453.74 m²/g.

FIG. 14 was generated by converting the adsorbed volumes at STP to specific adsorbed volume, SPV, through the use of Eq. 3(a) for each data point. The generated data was plotted on the left-y-axis against the relative pressure on the x-axis. The SSA was obtained by converting the specific volume data (FIG. 14, left-y-axis) to SSA data using Eq. 3(b). The obtained data is presented on the right-y-axis for the same curve. Once this graph was generated, the SPV and SSA was obtained at any suitable relative pressure (e.g., 0.95) by drawing a vertical line from the specified relative pressure (e.g., 0.95) until it intersected with the isotherm curve. Then a horizontal line was drawn to determine the SPV and SSA values from the left-y-axis and right-y-axis, respectively.

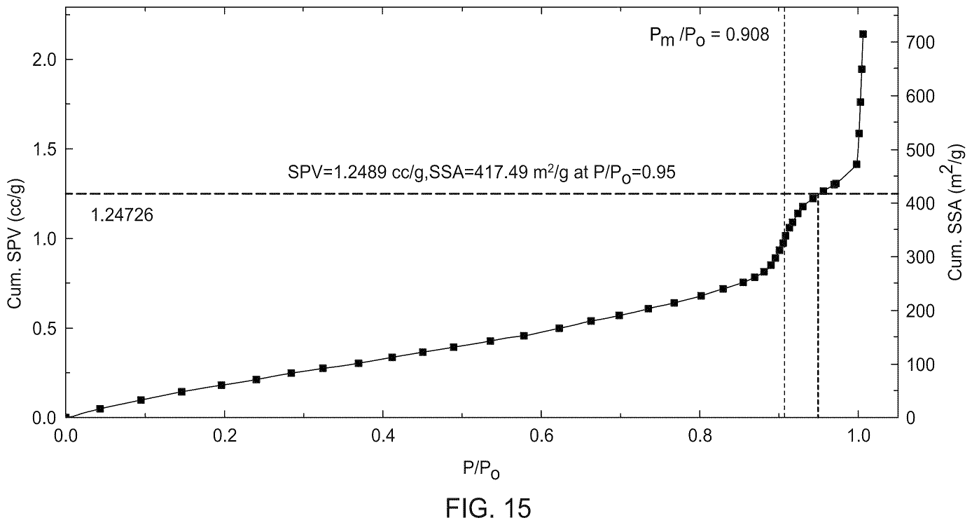

FIG. 15 shows SPV and SSA data for the MCM-41 (120 Å) sample using embodiments described herein. In the plot shown in FIG. 15, the vertical dashed line at a relative pressure of about 0.908 refers to capillary condensation relative pressure. The vertical dashed line at a relative pressure of about 0.95 refers to the pressure at which the SPV and SSA were determined. In this example, the cumulative SPV was determined to be about 1.2489 cc/g, and the cumulative SSA was determined to be about 417.49 m²/g.

FIG. 15 was generated by converting the adsorbed volumes at STP to specific adsorbed volume, SPV, through the use of Eq. 3(a) for each data point. The generated data was plotted on the left-y-axis against the relative pressure on the x-axis. The SSA is obtained by converting the specific volume data (FIG. 15, left-y-axis) to SSA data using Eq. 3(b). The obtained data is presented on the right-y-axis for the same curve. Once this graph was generated, the SPV and SSA was obtained at any suitable relative pressure (e.g., 0.95) by drawing a vertical line from the specified relative pressure (e.g., 0.95) until it intersected with the isotherm curve. Then a horizontal line was drawn to determine the SPV and SSA values from the left-y-axis and right-y-axis, respectively.

Table 4 shows a comparison between the results obtained using embodiments described herein versus the conventional nitrogen sorption method.

TABLE 4

| | Sample | | | |
|---|---|---|---|---|
| | MCM-41 (80 Å) | | MCM-41 (100 Å) | |
| | Example | Comparative | Example | Comparative |
| Method | Method | Method | Method | Method |
| BJH pore radius, Å | 43.876 | 39.148 | 49.155 | 47.668 |
| BJH pore volume, cc/g | 0.9954 | 0.993 | 1.1282 | 1.224 |
| BJH surface area | 453.74 | 455.606 | 459.04 | 494.860 |
| BET surface area, m²/g | 566.888 | 574.326 | 588.2609 | 657.042 |

| | Sample | |
|---|---|---|
| | MCM-41 (120 Å) | |
| Method | Example Method | Comparative Method |
| BJH pore radius, Å | 59.827 | 48.106 |
| BJH pore volume, cc/g | 1.2489 | 0.928 |
| BJH surface area | 417.49 | 364.565 |
| BET surface area, m²/g | 654.549 | 156.322 |

Embodiments described herein effectively predicted the pore radii of MCM-41 samples with nominal sizes of 80 Å and 100 Å as 43.876 Å and 49.155 Å, respectively, as presented in Table 4. In contrast, a conventional nitrogen sorption method yielded predictions of 39.148 Å and 47.668 Å for the same samples, aligning closely with the manufacturer specifications of 40 Å and 50 Å. Notably, the conventional method encountered challenges in estimating the pore radius of a higher-sized MCM-41 sample (120 Å), resulting in a prediction error of 19.8133% from the manufacturer's specified value of 60 Å. This discrepancy may be attributed to the limited pressure range employed in conventional nitrogen sorption methods, typically up to 14 psi, which inadequately fills larger pores with liquid nitrogen, leading to less accurate characterization. In addition, conventional methods cannot accurately measure pore sizes greater than 120 Å because of the low pressures used (up to only 14 psi). In contrast, embodiments of the present disclosure allow for pressures of adsorbate gas from 0 psi to 2,000 psi, thereby facilitating the determination of pore sizes greater than 120 Å.

Embodiments presented herein accurately estimated the pore radius of the MCM-41 (120 Å) sample as 59.827 Å (compared to the manufacturer's specification of 60 Å), demonstrating significantly improved accuracy relative to conventional methods. This enhancement in accuracy may be attributed to the methodology's ability to address the challenges posed by conventional nitrogen sorption methods in characterizing porous materials with larger pore sizes. In addition, embodiments described herein provide more data points, thereby improving the accuracy of the measurement relative to conventional methods.

### Example 3: Isobaric Capillary Condensation Experiments

The core holder was first filled with an adsorbent sample and hung inside the chamber from a hook or insulated cable (or wire) on the bottom of the mass comparator via an insulated cable. Next, the core holder and tubing of the apparatus were subjected to high vacuum and a temperature of approximately 100° C. to degas vapors in the system. Once degassing was finished, the pressure of the chamber was set to a desired experimental pressure (“Pₑₓₚ”).

To study fluid adsorption, a fluid was injected into the core holder at a desired experimental temperature (“T₁”). The temperature was set using the chamber, which uses feedback from a thermocouple or RTD. Constant temperature and pressure were maintained until fluid adsorption was complete, for example, until no changes in the mass or the temperature of the fluid were observed. Several adsorption measurements may be taken in sequence. Alternatively, an adsorption measurement may be taken, and once adsorption is complete, a desorption measurement may be taken.

To study fluid desorption, the mass and temperature of the adsorbed fluid were measured. Constant temperature and pressure was maintained until desorption of the fluid was complete (e.g., until no changes in the mass or the temperature of the fluid were observed). Once desorption was finished, the pressure of the chamber was set to Pₑₓₚ again, the temperature was increased to a new desired temperature (“T₂”), and the fluid was injected again until adsorption was complete. Several desorption measurements may be taken in sequence. Alternatively, a desorption measurement may be taken, and once desorption is complete, an adsorption measurement may be taken.

These adsorption and desorption steps were repeated, at constant pressure and different temperatures, as many times as desired. For example, the adsorption and desorption steps were repeated until a full adsorption isobaric plot (a plot of fluid amount adsorbed against temperature at a constant pressure) was created. Completion of adsorption was evidenced by constant mass and temperature readings for an extended period of time. Similarly, completion of desorption was evidenced by constant mass and temperature readings for an extended period of time. Mass readings were taken from the mass comparator, and temperature readings were taken with at least one thermometer housed inside the chamber. The time starting with adsorption or desorption and extending to a constant mass and temperature or to a constant mass and pressure reading was referred to as the “equilibrium time.”

### Example 4: Isothermal Capillary Condensation Experiment

The core holder was filled with an adsorbent sample and hung inside the chamber from a hook or insulated cable (or wire) on the bottom of the mass comparator via an insulated cable. Next, the core holder and tubing of the apparatus were subjected to high vacuum and a temperature of approximately 100° C. to degas vapors in the system. Once degassing was finished, the temperature of the chamber was set to a desired experimental temperature (“Tₑₓₚ”).

To study fluid adsorption, a fluid was injected into the core holder at a desired experimental pressure (“P₁”) by the Quizix pump. Constant temperature and pressure were maintained until fluid adsorption was complete (e.g., until no changes in the mass or the pressure of the fluid were observed). Several adsorption measurements may be taken in sequence. Alternatively, an adsorption measurement may be taken, and once adsorption is complete, a desorption measurement may be taken.

To study fluid desorption, the mass and pressure of the adsorbed fluid were measured. Constant temperature and pressure were maintained until desorption of the fluid was complete, for example, until no changes in the mass or the pressure of the fluid were observed. Once desorption was finished, the temperature of the chamber was set to Tₑₓₚ again, the pressure was increased to a new desired pressure (“P₂”), and the fluid was injected again until adsorption was complete. Several desorption measurements may be taken in sequence. Alternatively, a desorption measurement may be taken, and once desorption is complete, an adsorption measurement may be taken.

These adsorption and desorption steps were repeated, at constant temperature and different pressures, as many times as desired. For example, the adsorption and desorption steps were repeated until a full adsorption isotherm (a plot of fluid amount adsorbed against pressure at constant temperature) was created. Completion of adsorption was evidenced by constant mass and pressure readings for an extended period of time. Similarly, completion of desorption was evidenced by constant mass and pressure readings for an extended period of time. Mass readings were taken from the mass comparator, and pressure readings were taken from pressure transducers or vacuum gauges located outside of the chamber.

If the adsorption/desorption processes did not exhibit hysteresis, the desorption pressure was the same as the pressure of adsorption. If the adsorption/desorption process exhibited hysteresis, the desorption pressure was greater than the pressure of adsorption.

Embodiments described herein generally relate to new methods and apparatus for characterizing porous materials, such as nanoporous materials. Embodiments described herein provide more versatility relative to conventional technologies. Here, more and higher temperatures and more and higher pressures may be utilized during characterization of porous materials. Also, while conventional technologies solely utilize N₂ adsorbate gases, many more adsorbate gases may be utilized with embodiments described herein, allowing better characterization of nanoporous materials. In addition, by determining gravimetric values, the data obtained by using embodiments described herein is more reliable, accurate, and reproducible than conventional methods.

### EMBODIMENTS LISTING

The present disclosure provides, among others, the following embodiments, each of which may be considered as optionally including any alternate embodiments:

Embodiment A1. A gravimetric method for characterizing a nanoporous material, comprising:
contacting a nanoporous material with an adsorbate gas, the nanoporous material positioned inside a core holder;
collecting adsorption data, desorption data, or combinations thereof, the adsorption data and desorption data comprising gravimetric data;
plotting an adsorption isotherm from the adsorption data, a desorption isotherm from the desorption data, or combinations thereof;
converting the gravimetric data from gravimetric values to volumetric values;
selecting a pore geometry for the nanoporous material; and
determining one or more characteristics of the nanoporous material.

Embodiment A2. The gravimetric method according to Embodiment A1, wherein, prior to contacting the nanoporous material with the adsorbate gas, the gravimetric method further comprises:
disposing a nanoporous material inside the core holder, the core holder positioned inside of a chamber of a characterization apparatus;
applying a vacuum to one or more components of the characterization apparatus; and
setting an experimental temperature at which the adsorption data, desorption data, or combinations thereof are collected.

Embodiment A3. The gravimetric method according to any one of the preceding Embodiments, wherein collecting adsorption data, desorption data, or combinations thereof comprises: collecting mass readings from a mass comparator operationally connected to an exterior of the core holder.

Embodiment A4. The gravimetric method according to any one of the preceding Embodiments, wherein the adsorbate gas comprises H₂, CO₂, a hydrocarbon, natural gas, He, N₂, or combinations thereof.

Embodiment A5. The method according to any one of the preceding Embodiments, wherein the one or more characteristics of the nanoporous material comprises surface area, pore volume, pore size, pore size distribution, or combinations thereof.

Embodiment A6. The gravimetric method according to any one of the preceding Embodiments, wherein converting the gravimetric data from the gravimetric values to the volumetric values comprises:

converting absolute adsorbed mass data into adsorbed volume at standard temperature and pressure conditions by Eq. 1(a):

$$Volume of adsorbate gas adsorbed = \frac{mass of adsorbate gas adsorbed}{Density of adsorbate gas at STP} ; \qquad ( Eq . 1 ( a ) )$$

converting an absolute pressure of the adsorbed gas inside the core holder into a relative pressure (relative P) of the adsorbed gas by normalization with a saturation pressure of the adsorbate gas at an experimental temperature at which the adsorption data, desorption data, or combinations thereof are collected according to Eq. 1(b):

$$Relative pressure of adsorbed gas = \frac{Absolute pressure of adsorbed gas}{Saturation pressure of adsorbate gas} . \qquad ( Eq . 1 ( b ) )$$

Embodiment A7. The gravimetric method according to any one of the preceding Embodiments, wherein determining the one or more characteristics of the nanoporous material comprises: determining a BET specific surface area of the nanoporous material.

Embodiment A8. The gravimetric method according to any one of the preceding Embodiments, wherein determining the one or more characteristics of the nanoporous material comprises: determining a specific pore volume of the nanoporous material by Eq. 3(a):

$$specific pore volume ( SPV ) = \frac{{V}_{S T P} * {M}_{g a s}}{M V * {ρ}_{L}} , \qquad ( Eq . 3 ( a ) )$$

wherein: V_{STP} is adsorbed volume of the adsorbate gas at standard temperature and pressure; M_{gas} is molar mass of the adsorbate gas; ρ_{L} is liquid density of the adsorbate gas at an experimental temperature at which the adsorption data, desorption data, or combinations thereof are collected; and MV is molar volume of the adsorbate gas.

Embodiment A9. The gravimetric method according to any one of the preceding Embodiments, wherein determining the one or more characteristics of the nanoporous material comprises: determining a specific surface area of the nanoporous material by Eq. 3(b):

$$specific surface area = 2 * \frac{{V}_{p}}{{r}_{p}} , \qquad ( Eq . 3 ( b ) )$$

wherein: Vₚ is specific pore volume; and rₚ is corresponding radius of the pores.

Embodiment A10. The gravimetric method according to any one of the preceding Embodiments, wherein determining the one or more characteristics of the nanoporous material comprises determining a pore size distribution of the nanoporous material, wherein determining the pore size distribution of the nanoporous material comprising: converting a relative pressure of the adsorbed gas into a Kelvin radius by Eq. 4:

$${r}_{k} = \frac{γ * {V}_{l}}{R * T * ln ( \frac{P}{{P}_{o}} )} , \qquad ( Eq . 4 )$$

wherein: rₖ is Kelvin radius of the pores at the corresponding relative pressure of the adsorbed gas; γ is surface tension of the adsorbate gas; Vₗ is molar volume of liquid adsorbate; R is universal gas constant; T is Kelvin temperature; ln is natural logarithm; and

$$\frac{P}{{P}_{o}}$$

is relative pressure of the adsorbed gas.

Embodiment A11. The gravimetric method according to Embodiment A10, wherein determining the pore size distribution of the nanoporous material further comprises:
plotting the Kelvin radius with the volume of the adsorbate gas adsorbed; and
plotting a differentiation of the adsorbed volume with respect to a pore size (2×rₖ) of the nanoporous material (dVp/dwp) against the pore size (2×rₖ) of the nanoporous material to determine the pore size distribution of the nanoporous material.

Embodiment B1. A gravimetric method for characterizing a nanoporous material, comprising:
disposing a nanoporous material inside a core holder of a characterization apparatus;
applying a vacuum to one or more components of the characterization apparatus;
setting an experimental temperature at which the adsorption data, desorption data, or combinations thereof are collected;
contacting the nanoporous material with an adsorbate gas;
collecting adsorption data, desorption data, or combinations thereof, the adsorption data and desorption data comprising gravimetric data;
plotting an adsorption isotherm from the adsorption data, a desorption isotherm from the desorption data, or combinations thereof;
converting the gravimetric data from gravimetric values to volumetric values;
selecting a pore geometry for the nanoporous material; and
determining one or more characteristics of the nanoporous material.

Embodiment B2. The gravimetric method according to Embodiment B1, wherein collecting adsorption data, desorption data, or combinations thereof comprises: collecting mass readings from a mass comparator operationally connected to an exterior of the core holder.

Embodiment B3. The gravimetric method according to any one of Embodiments B1-B2, wherein the adsorbate gas comprises H₂, CO₂, a hydrocarbon, natural gas, He, N₂, or combinations thereof.

Embodiment B4. The method according to any one of Embodiments B1-B3, wherein the one or more characteristics of the nanoporous material comprises surface area, pore volume, pore size, pore size distribution, or combinations thereof.

Embodiment B5. The gravimetric method according to any one of Embodiments B1-B4, wherein determining the one or more characteristics of the nanoporous material comprises: determining a BET specific surface area of the nanoporous material.

Embodiment B6. The gravimetric method according to any one of Embodiments B1-B5, wherein determining the one or more characteristics of the nanoporous material comprises:
determining a BJH specific pore volume of the nanoporous material;
determining a BJH specific surface area of the nanoporous material; or
a combination thereof.

Embodiment B7. The gravimetric method according to any one of Embodiments B1-B6, wherein determining the one or more characteristics of the nanoporous material comprises determining a pore size distribution of the nanoporous material, wherein determining the pore size distribution of the nanoporous material comprising:
converting a relative pressure of the adsorbed gas into a Kelvin radius;
plotting the Kelvin radius with the volume of the adsorbate gas adsorbed; and
plotting a differentiation of the adsorbed volume with respect to a pore size (2×rₖ) of the nanoporous material (dVp/dwp) against the pore size (2×rₖ) of the nanoporous material to determine the pore size distribution of the nanoporous material.

Embodiment C1. A gravimetric nanocondensation apparatus for characterizing a nanoporous material, the gravimetric nanocondensation apparatus comprising:
a core holder;
a pressure sensor coupled to the core holder, the pressure sensor configured to sense a pressure within the core holder and produce a pressure signal;
a mass comparator operationally connected to an exterior of the core holder;
a valve configured to control flow of adsorbate gas into the core holder and configured to control pressure within the core holder;
a controller coupled to the pressure sensor, the valve, and the mass comparator, the controller configured to:
   cause flow of the adsorbate gas into the core holder to contact the nanoporous material by opening the valve; and
   cause collection of adsorption data, desorption data, or combinations thereof, the adsorption data and desorption data comprising gravimetric data by logging data from the pressure sensor and the mass comparator.

Embodiment C2. The gravimetric nanocondensation apparatus according to Embodiment C1, wherein the adsorbate gas comprises H₂, CO₂, a hydrocarbon, natural gas, He, N₂, or combinations thereof.

Embodiment D1. A gravimetric nanocondensation apparatus for characterizing a nanoporous material, the gravimetric nanocondensation apparatus comprising:
a chamber having a port therein;
a mass comparator positioned above and outside of the chamber;
a hook (or an insulated cable or wire) hanging inside the chamber and attached to a bottom surface of the mass comparator, the hook or the insulated cable traversing through an interior and an exterior of the chamber via the port;
a core holder positioned inside the chamber and hanging from the hook (or the insulated cable or the wire), the mass comparator operationally connected to an exterior of the core holder;
a pressure sensor coupled to the core holder, the pressure sensor configured to sense a pressure within the core holder and produce a pressure signal;
a valve configured to control flow of adsorbate gas into the core holder and configured to control pressure within the core holder;
a pump coupled to the valve, the pump configured to pressurize the adsorbate gas;
a controller coupled to the pressure sensor, the valve, and the mass comparator, the controller configured to:
   cause flow of the adsorbate gas from the pump and into the core holder to contact the nanoporous material by opening the valve; and
   cause collection of adsorption data, desorption data, or combinations thereof, the adsorption data and desorption data comprising gravimetric data by logging data from the pressure sensor and the mass comparator.

Embodiment D2. The gravimetric nanocondensation apparatus according to Embodiment D1, further comprising a gas source coupled to the pump, the gas source comprising the adsorbate gas, the adsorbate gas comprising H₂, CO₂, a hydrocarbon, natural gas, He, N₂, or combinations thereof.

Embodiment E1. A gravimetric method for characterizing a nanoporous material, comprising: (a) disposing a nanoporous material inside a core holder of a characterization apparatus; (b) applying a vacuum to one or more components of the characterization apparatus; (c) setting an experimental temperature; (d) initiating an experiment by contacting the nanoporous material with an adsorbate gas and collecting adsorption data, desorption data, or combinations thereof; (e) plotting an adsorption isotherm from the adsorption data, a desorption isotherm from the desorption data, or combinations thereof; (f) selecting the adsorption isotherm or the desorption isotherm, the adsorption isotherm and the desorption isotherm comprising gravimetric data; (g) converting the gravimetric data from gravimetric values to volumetric values; (h) selecting a pore geometry for the nanoporous material; and (i) determining one or more characteristics of the nanoporous material.

Embodiment E2. The gravimetric method according to Embodiment E1, wherein the adsorbate gas comprises H₂, CO₂, C₂H₆, He, N₂, or combinations thereof.

Embodiment E3. The method according to any one of Embodiments E1-E2, wherein the one or more characteristics of the nanoporous material comprises surface area, pore volume, pore size, pore size distribution, or combinations thereof.

All documents described herein are incorporated by reference herein, including any priority documents and/or testing procedures to the extent they are not inconsistent with this text. As is apparent from the foregoing general description and the specific embodiments, while forms of the embodiments have been illustrated and described, various modifications may be made without departing from the spirit and scope of the present disclosure. Accordingly, it is not intended that the present disclosure be limited thereby. Likewise, the term “comprising” is considered synonymous with the term “including.” Likewise whenever a composition, an element, a group of elements, or a method is preceded with the transitional phrase “comprising,” it is understood that we also contemplate the same composition, method, or group of elements with transitional phrases “consisting essentially of,” “consisting of,” “selected from the group of consisting of,” or “Is” preceding the recitation of the composition, element, elements, or method, and vice versa, such as the terms “comprising,” “consisting essentially of,” “consisting of” also include the product of the combinations of elements listed after the term.

In the foregoing, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the foregoing embodiments, features, aspects, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

For purposes of this present disclosure, and unless otherwise specified, all numerical values within the detailed description and the claims herein are modified by “about” or “approximately” the indicated value, and consider experimental error and variations that would be expected by a person having ordinary skill in the art. It will be further understood that there are a number of values disclosed therein, and that each value is also herein disclosed as “about” that particular value in addition to the value itself. In embodiments, use of the term “about” may refer to ±20% of the stated value, ±15% of the stated value, ±10% of the stated value, ±5% of the stated value, ±3% of the stated value, ±2% of the stated value, or ±1% of the stated value.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

Moreover, all numerical end points of ranges disclosed herein are approximate, unless excluded by proviso. As a representative example, if one or more operations in the processes described herein may be conducted at a temperature in a range from 10° C. to 75° C., this range should be interpreted as encompassing temperatures in a range from “about” 10° C. to “about” 75° C.

As used herein, the indefinite article “a” or “an” shall mean “at least one” unless specified to the contrary or the context clearly indicates otherwise. For example, embodiments comprising “a fluid” include embodiments comprising one, two, or more fluids, unless specified to the contrary or the context clearly indicates only one fluid is included.

While the foregoing is directed to embodiments of the present disclosure, other and further embodiments of the disclosure may be devised without departing from the basic scope thereof, and the scope thereof is determined by the claims that follow.

What is claimed is:

1. A gravimetric method for characterizing a nanoporous material, comprising:
contacting a nanoporous material with an adsorbate gas, the nanoporous material positioned inside a core holder;
collecting adsorption data, desorption data, or combinations thereof, the adsorption data and desorption data comprising gravimetric data;
plotting an adsorption isotherm from the adsorption data, a desorption isotherm from the desorption data, or combinations thereof;
converting the gravimetric data from gravimetric values to volumetric values;
selecting a pore geometry for the nanoporous material; and
determining one or more characteristics of the nanoporous material.

2. The gravimetric method according to claim 1, wherein, prior to contacting the nanoporous material with the adsorbate gas, the gravimetric method further comprises:
disposing a nanoporous material inside the core holder, the core holder positioned inside of a chamber of a characterization apparatus;
applying a vacuum to one or more components of the characterization apparatus; and
setting a temperature at which the adsorption data, desorption data, or combinations thereof are collected.

3. The gravimetric method according to claim 1, wherein collecting adsorption data, desorption data, or combinations thereof comprises:
collecting mass readings from a mass comparator operationally connected to an exterior of the core holder.

4. The gravimetric method according to claim 1, wherein the adsorbate gas comprises H₂, CO₂, a hydrocarbon, natural gas, He, N₂, or combinations thereof.

5. The method according to claim 1, wherein the one or more characteristics of the nanoporous material comprise surface area, pore volume, pore size, pore size distribution, or combinations thereof.

6. The gravimetric method according to claim 1, wherein converting the gravimetric data from the gravimetric values to the volumetric values comprises:
converting absolute adsorbed mass data into adsorbed volume at standard temperature and pressure conditions by Eq. 1(a):
$$Volume of adsorbate gas adsorbed = \frac{mass of adsorbate gas adsorbed}{Density of adsorbate gas at STP} ; \qquad ( Eq . 1 ( a ) )$$
and
converting an absolute pressure of the adsorbed gas inside the core holder into a relative pressure (relative P) of the adsorbed gas by normalization with a saturation pressure of the adsorbate gas at the temperature at which the adsorption data, desorption data, or combinations thereof are collected according to Eq. 1(b):
$$Relative pressure of adsorbed gas = \frac{Absolute pressure of adsorbed gas}{Saturation pressure of adsorbate gas} . \qquad ( Eq . 1 ( b ) )$$

7. The gravimetric method according to claim 1, wherein determining the one or more characteristics of the nanoporous material comprises:
determining a BET specific surface area of the nanoporous material.

8. The gravimetric method according to claim 1, wherein determining the one or more characteristics of the nanoporous material comprises:
determining a specific pore volume of the nanoporous material by Eq. 3(a):
$$specific pore volume ( SPV ) = \frac{{V}_{S T P} * {M}_{g a s}}{M V * {ρ}_{L}} , \qquad ( Eq . 3 ( a ) )$$
wherein: V_{STP} is adsorbed volume of the adsorbate gas at standard temperature and pressure; M_{gas} is molar mass of the adsorbate gas; ρ_{L} is liquid density of the adsorbate gas at the temperature at which the adsorption data, desorption data, or combinations thereof are collected; and
MV is molar volume of the adsorbate gas.

9. The gravimetric method according to claim 1, wherein determining the one or more characteristics of the nanoporous material comprises:
determining a specific surface area of the nanoporous material by Eq. 3(b):
$$specific surface area = 2 * \frac{{V}_{p}}{{r}_{p}} , \qquad ( Eq . 3 ( b ) )$$
wherein: Vₚ is specific pore volume; and rₚ is corresponding radius of the pores.

10. The gravimetric method according to claim 1, wherein determining the one or more characteristics of the nanoporous material comprises determining a pore size distribution of the nanoporous material, wherein determining the pore size distribution of the nanoporous material comprises:
converting a relative pressure of the adsorbed gas into a Kelvin radius by Eq. 4:
$${r}_{k} = \frac{γ * {V}_{l}}{R * T * ln ( \frac{P}{{P}_{o}} )} \qquad ( Eq . 4 )$$
wherein: rₖ is Kelvin radius of the pores at the corresponding relative pressure of the adsorbed gas; γ is surface tension of the adsorbate gas; Vₗ is molar volume of liquid adsorbate; R is universal gas constant; T is Kelvin temperature; ln is natural logarithm; and
$$\frac{P}{{P}_{o}}$$
is relative pressure of the adsorbed gas.

11. The gravimetric method according to claim 10, wherein determining the pore size distribution of the nanoporous material further comprises:
plotting the Kelvin radius with the volume of the adsorbate gas adsorbed; and
plotting a differentiation of the adsorbed volume with respect to a pore size (2×rₖ) of the nanoporous material (dVp/dwp) against the pore size (2×rₖ) of the nanoporous material to determine the pore size distribution of the nanoporous material.

12. A gravimetric method for characterizing a nanoporous material, comprising:
disposing a nanoporous material inside a core holder of a characterization apparatus;
applying a vacuum to one or more components of the characterization apparatus;
setting a temperature at which the adsorption data, desorption data, or combinations thereof are collected;
contacting the nanoporous material with an adsorbate gas;
collecting adsorption data, desorption data, or combinations thereof, the adsorption data and desorption data comprising gravimetric data;
plotting an adsorption isotherm from the adsorption data, a desorption isotherm from the desorption data, or combinations thereof;
converting the gravimetric data from gravimetric values to volumetric values;
selecting a pore geometry for the nanoporous material; and
determining one or more characteristics of the nanoporous material.

13. The gravimetric method according to claim 12, wherein collecting adsorption data, desorption data, or combinations thereof comprises:
collecting mass readings from a mass comparator operationally connected to an exterior of the core holder.

14. The gravimetric method according to claim 12, wherein the adsorbate gas comprises H₂, CO₂, a hydrocarbon, natural gas, He, N₂, or combinations thereof.

15. The method according to claim 12, wherein the one or more characteristics of the nanoporous material comprise surface area, pore volume, pore size, pore size distribution, or combinations thereof.

16. The gravimetric method according to claim 12, wherein determining the one or more characteristics of the nanoporous material comprises:
determining a BET specific surface area of the nanoporous material.

17. The gravimetric method according to claim 12, wherein determining the one or more characteristics of the nanoporous material comprises:
determining a BJH specific pore volume of the nanoporous material;
determining a BJH specific surface area of the nanoporous material; or
a combination thereof.

18. The gravimetric method according to claim 12, wherein determining the one or more characteristics of the nanoporous material comprises determining a pore size distribution of the nanoporous material, wherein determining the pore size distribution of the nanoporous material comprises:
converting a relative pressure of the adsorbed gas into a Kelvin radius;
plotting the Kelvin radius with the volume of the adsorbate gas adsorbed; and
plotting a differentiation of the adsorbed volume with respect to a pore size (2×rₖ) of the nanoporous material (dVp/dwp) against the pore size (2×rₖ) of the nanoporous material to determine the pore size distribution of the nanoporous material.

19. A gravimetric nanocondensation apparatus for characterizing a nanoporous material, the gravimetric nanocondensation apparatus comprising:
a core holder;
a pressure sensor coupled to the core holder, the pressure sensor configured to sense a pressure within the core holder and produce a pressure signal;
a mass comparator operationally connected to an exterior of the core holder;
a valve configured to control flow of adsorbate gas into the core holder and configured to control pressure within the core holder;
a controller coupled to the pressure sensor, the valve, and the mass comparator, the controller configured to:
cause flow of the adsorbate gas into the core holder to contact the nanoporous material by opening the valve; and
cause collection of adsorption data, desorption data, or combinations thereof, the adsorption data and desorption data comprising gravimetric data by logging data from the pressure sensor and the mass comparator.

20. The gravimetric nanocondensation apparatus of claim 19, wherein the adsorbate gas comprises H₂, CO₂, a hydrocarbon, natural gas, He, N₂, or combinations thereof.
